(19) United States
(12) Patent Application Publication
(10) Pub. No.: US 2008/0077497 A1
(43) Pub. Date: Mar. 27, 2008

(54) NETWORKED COMMUNICATIONS SYSTEM AND VIRTUAL COMMUNITY ACCESSED THEREWITH

(76) Inventor: MARTIN SALKEY, TAMARAC, FL (US)

Correspondence Address: ROBERT M. SCHWARTZ, P.A., P.O. BOX 221470, HOLLYWOOD, FL, 33022, US

(21) Appl. No.: 11/861,732

(22) Filed: Sep. 26, 2007

Related U.S. Application Data
(60) Provisional application No. 60/826,937, filed on Sep. 26, 2006.

(51) Int. Cl. G06Q 30/00

(52) U.S. Cl. 705/14

(57) ABSTRACT

A bonus tracking system and method is provided wherein bonuses are tracked based on individuals referring other individuals to a service. Bonuses are paid based upon the services rendered by the referred individuals. Referring individuals are awarded a bonus based on individuals directly referred, as well as indirectly referred individuals.

### INDEX TO RELATED APPLICATIONS

This Application claims benefit of U.S. Provisional Patent Application Ser. No. 60/826,937, filed Sep. 26, 2006, the disclosure of which is incorporated herein, by reference, in its entirety.

### BACKGROUND OF THE INVENTION

The future of competitive business will lie within its flexibility and availability. With time we have seen the changes in this progression from computers, cell phones, and instant emails. In the continuation of this ultimate availability from any where in the worlds has derived the concept and software of the ultimate complete virtual office. The goal is to continue to provide unlimited access of your business to your customers, instant crucial decision making information in an instant, sharing of files and information with a complete organization, while providing necessary management tools to continue providing the highest possible customer service. Apart from the competitive edge that is created by being able to offer such services and operating at an innovative level, organization costs are being reduced by a significant amount.

This revolutionary way of conducting and running a business will be accomplished by our new innovative and cutting edge technology. This new technology that everyone in the world will require to keep apace within the competitive business industry will provide features which will enable business owners to run a company with substantially reduced overhead costs while still overseeing the details of everyday transactions and simultaneously providing the employees with easy to manage tools that will keep them one step ahead of the competition. This concept is accomplished by having a one stop virtual office solution, which will operate as a traditional office with the exception that is conducted online and is completely automotive. This system will be capable of organizing and storing emails, track leads, set-up marketing campaigns, conduct accounting activities, track files at every stage, capabilities to mange accounts, store and view files, create marketing strategies, create personal calendars', make phone calls, send faxes, have the ability to create message mailboxes, store documents, organize and set up individual departments, and conduct live video conferencing while providing the tools for customers to communicate and see live representative online or on their cell phone from anywhere in the world.

From the business owners point of view the software allows for complete control over daily activities and the capabilities of expanding without having to lease more office space. This will not only allow for a business to run at reduced costs and more efficiently, but it will also allow for precise handling of customers, files, sales force, and growth. This is all accomplished by having easy management over all these aspects by always having it available just a click away. While accomplishing all of these essential tasks the business is being perceived and acknowledged as being ahead of the curb by having and providing cutting edge technology not found anywhere else.

Having this product is not only advantageous for the business owner but it also provides employees with tools that will differentiate them from any competitor. The employees and customers will have the capabilities to mange their accounts, store and view files, create marketing strategies, have personal calendars', make phone calls, send faxes, have the ability to create message mailboxes, store documents, and conduct live video conferencing. The best part of all is that these capabilities will either be accessible from their computer or their cell phone, allowing them to conduct business anywhere. Imagine a Realtor doing a live viewing of a property with a client that is in another country, they will be able to see in real time exactly what they are purchasing without any questions or doubts.

Another added benefit is that customer will have a lot of extra services that are not provided by many other companies. Customers will have the capability to communicate and see live representative online or on your cell phone from anywhere in the world. This means that a service does not stop at a phone call, given the fact that employees have complete access to office information at their fingertips actual business transactions can be conducted from anywhere since everything they need will be at their fingertips.

It is hard to imagine a world without the internet or even more dramatically without cell phones, and even though it may seem like a drastic comparison now in a few years we will be saying the same life altering statement about virtual office. It will be something every business will need to have and something we will not envision ourselves living without.

The invention relates to a networked communications system and a virtual community accessed therewith. More particularly, parties communicate, electronically and/or by telephone, with a virtual community accessible through a networked communications system, in order to conduct transactions, “meet” and communicate with other parties and/or access information.

### SUMMARY OF THE INVENTION

The system of the present invention provides customers the ability to:
Have their personal online virtual office.
See and talk to live representatives on line or on their cell phone.
Conduct live video conferencing and chats.
Buy or sell real estate (residential, commercial, foreclosures).
Obtain a mortgage (purchase, refinance, commercial, investment).
Buy insurance (auto, home, life, health, retirement products).
Book a travel (flight, hotel, ticket events, cruises, vacation packages).
Send video mail.
Write blogs.
Conduct polls.
Create classifieds, quizzes, and events.
Send instant messages.

### All of these tools provide each member the capability to conduct business from anywhere in the world.

There are social benefits that customers can also benefit from, such as:
Meeting friends.
Networking on a global scale.
Create wealth by becoming part of One Stop Solution Inc.
Building network marketing teams.
Keeping track of your sign-ups and friends.

Each member has the ability to build their team and create wealth by:
Conducting network marketing capabilities to our four divisions.
This means that each member can get paid when using these services for themselves and for the services obtained by their sign-ups/team.
Receiving residuals for up to 5 generations. There is no limit to how large your team can be.
This means an unlimited amount of residual income for life.

### All these tools combined create a virtual workplace community that allows each individual to work, play, and get paid in one place.

Other features which are considered as characteristic for the invention are set forth in the appended claims.

Although the invention is illustrated and described herein as embodied in a networked communications system and virtual community accessed therewith, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### DESCRIPTION

Our society is currently in a work force transition, we are in the beginning stages of becoming a virtual work society. This means that in the next several years we will see more and more business conducting transactions from a virtual work space than an office or similar physical location.

This revolutionary way of conducting and running a business will be accomplished by our new innovative and cutting edge technology. This new technology, that everyone in the world will require to keep apace within the competitive and ever so changing business industry, will provide features which will enable business owners to run a company with substantially reduced overhead costs while still overseeing the details of everyday transactions while simultaneously providing the employees with easy to manage tools that will keep them one step ahead of the competition. This concept is accomplished by having a one stop virtual office solution, which will operate as a traditional office with the exception that is conducted online and is completely automotive. This system will be capable of organizing and storing emails, track leads, set-up marketing campaigns, conduct account activities, track files at every stage, capabilities to manage accounts, store and view files, create marketing strategies, create personal calendars', make phone calls, send faxes, have the ability to create message mailboxes, store documents, organize and set up individual departments, conduct live video conferencing, and the ability to see live representatives either on line or on your cell phone.

Business owners also have additional benefits by operating as a virtual office, this includes being able to have complete control over daily activities from any location, and having the capabilities of expanding without having to lease office space. This will not only allow for a business to run at a reduce cost, it will run more efficiently by allowing for precise handling of customers, files, sales force, and growth. This is all accomplished by creating an easy access management workspace accessible from any location. While accomplishing all of these essential tasks the business is being portrayed as being ahead of the curb by having and providing cutting edge technology.

This product is not only advantageous for the business owner but it also provides employees the capabilities to manage their accounts, store and view files, create marketing strategies, create personal calendars', make phone calls, send faxes, have the ability to create message mailboxes, store documents, organize and set up individual departments, conduct live video conferencing, and the ability to see live representatives either on line or on your cell phone.

Customers also have their own added benefits, such as the capability to communicate and see live representatives on line or on their cell phone from anywhere in the world. This means that business transactions can be conducted from anywhere at anytime since everything needed is at their fingertips.

### BRIEF DESCRIPTION OF THE DRAWINGS

FIG. 1 is a flow chart showing the steps that a customer can select using the system and method of the present invention.

FIG. 2 is a flow chart showing the system and method of the present invention whereby the customer can choose an English or Spanish presentation.

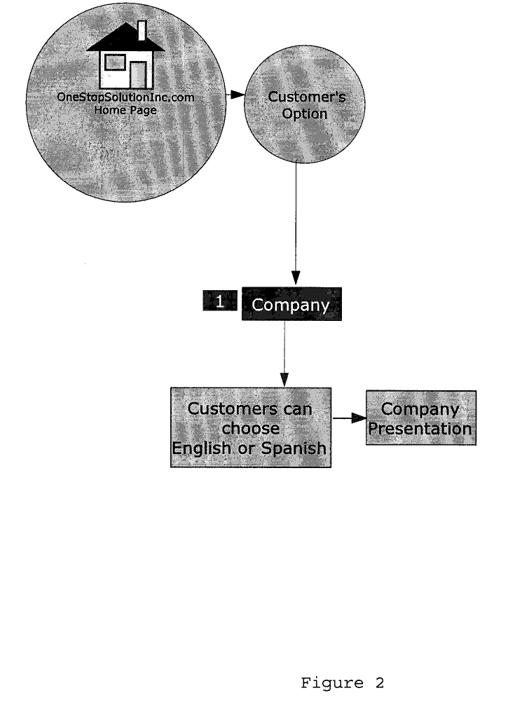

FIG. 3 is a flow chart showing the system and method of the present invention where a customer can join a specific portal for a defined company.

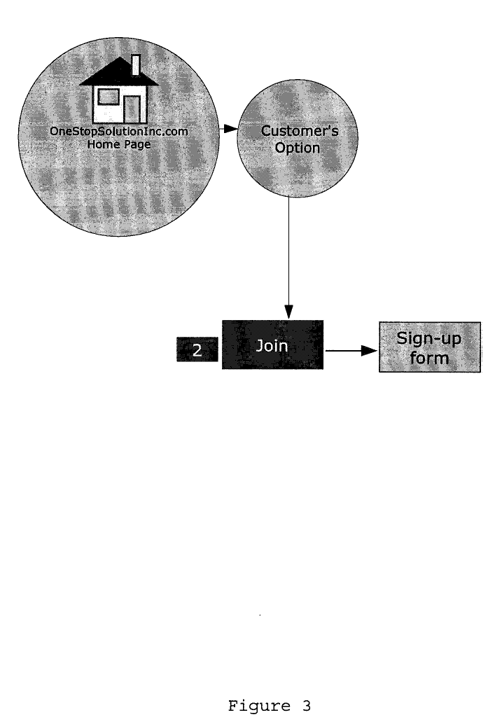

FIG. 4 is a flow chart showing the system and method of the present invention used in a real estate environment.

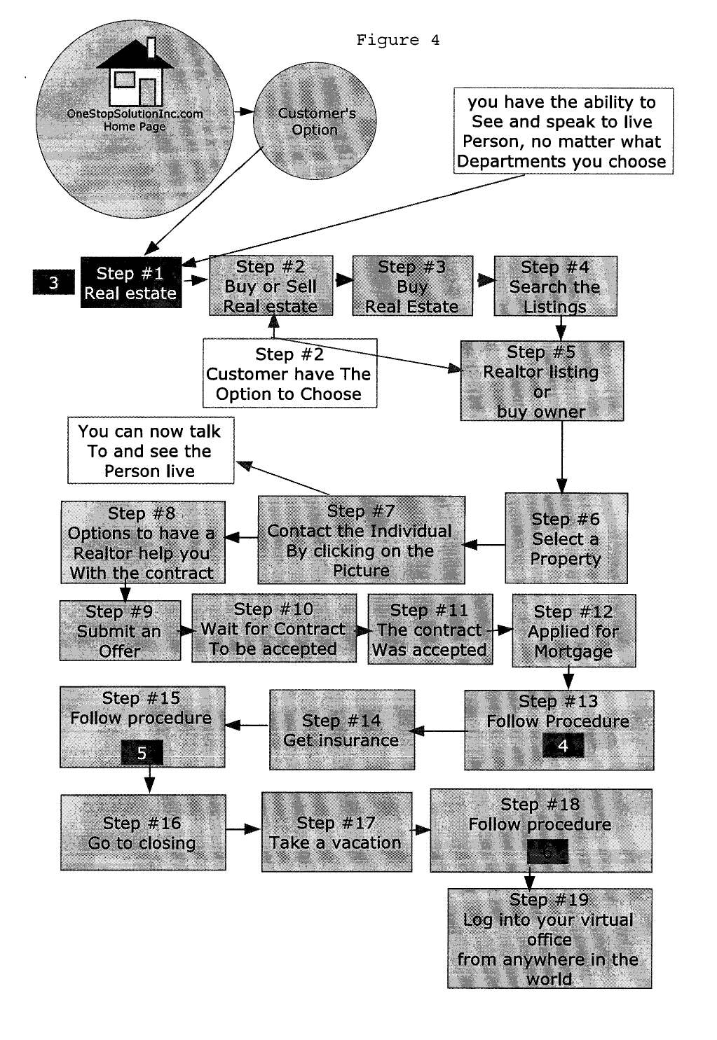

FIG. 5 is a flow chart showing the system and method of the present invention in a mortgage environment.

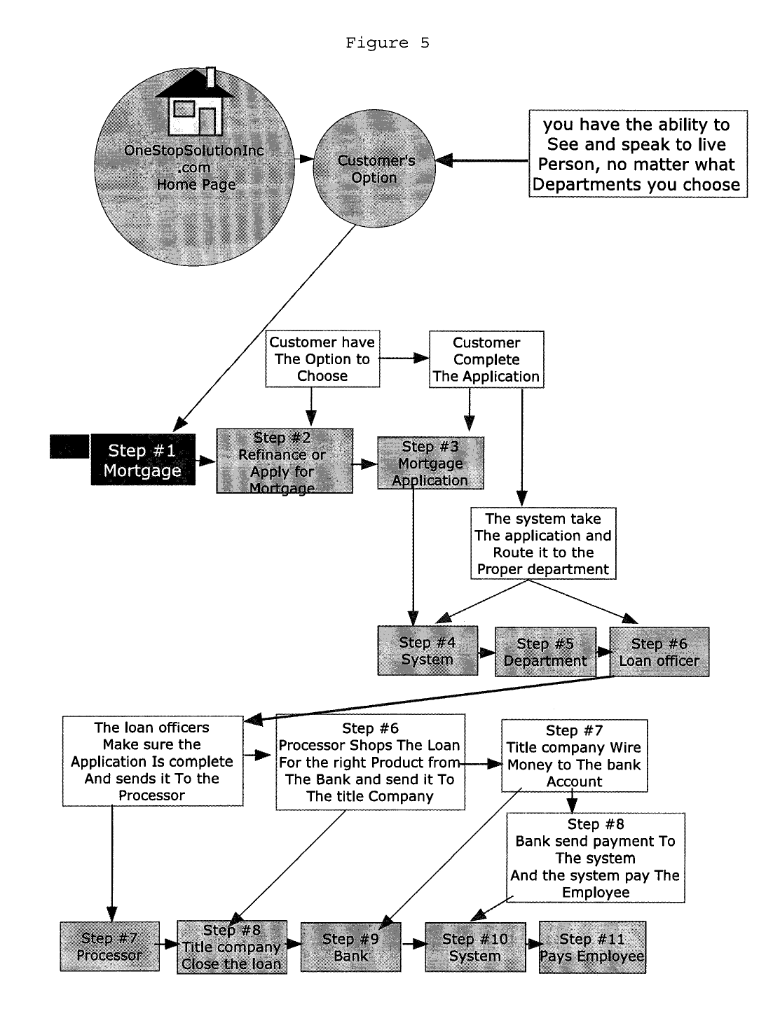

FIG. 6 is a flow chart showing the system and method of the present invention in an insurance environment.

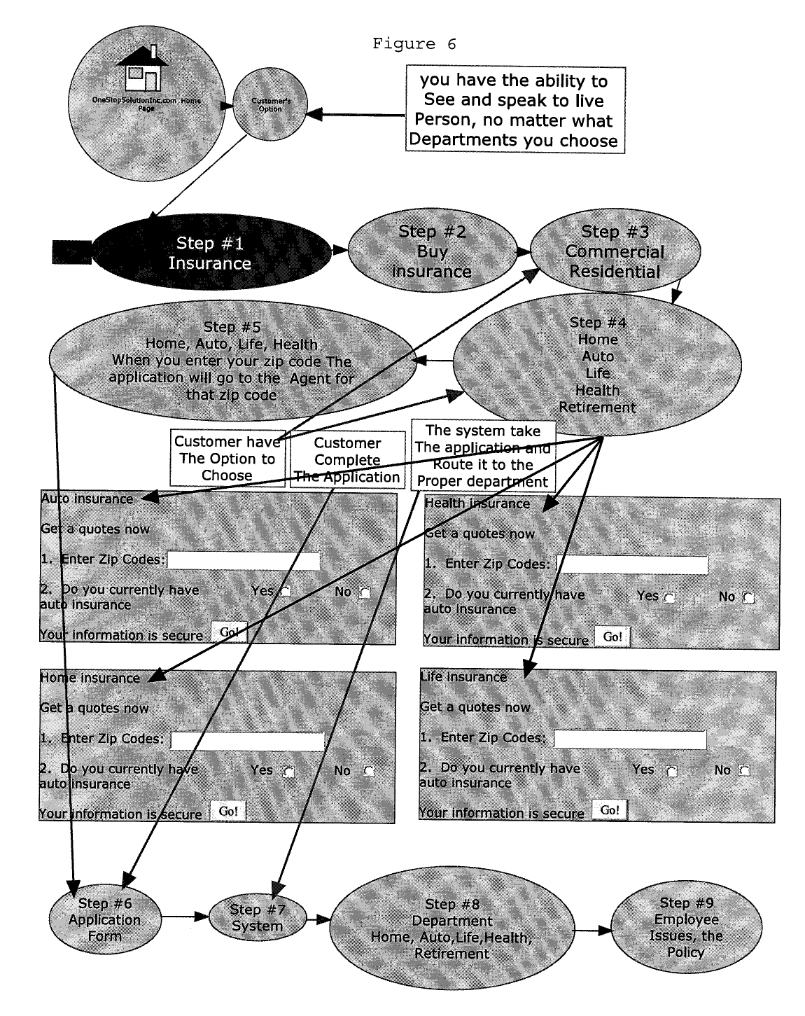

FIG. 7 is a flow chart showing the system and method of the present invention in a travel environment.

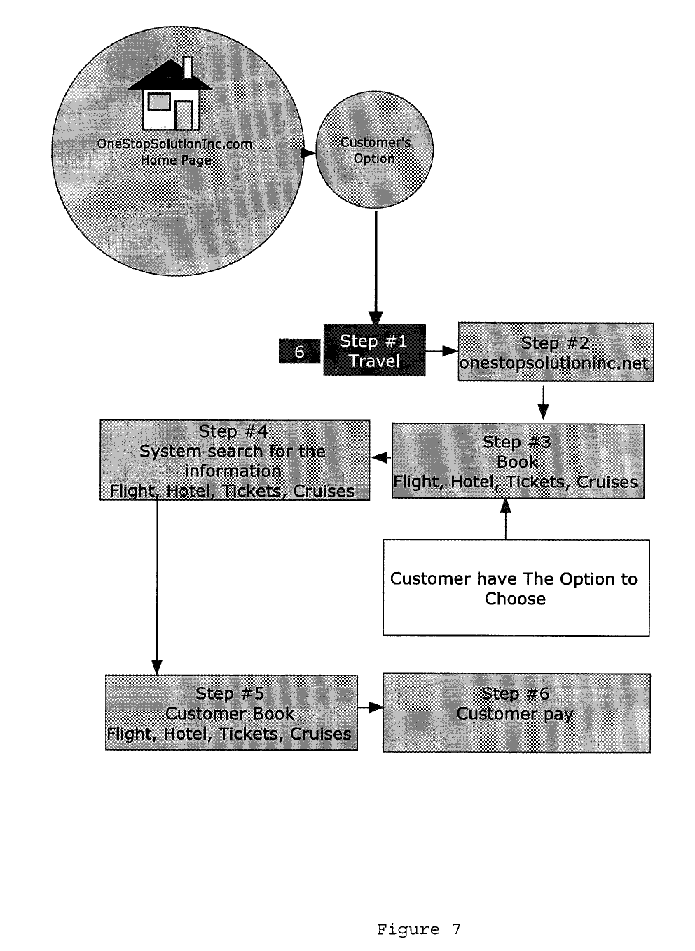

FIG. 8 is a flow chart showing the system and method of the present invention utilizing a virtual office.

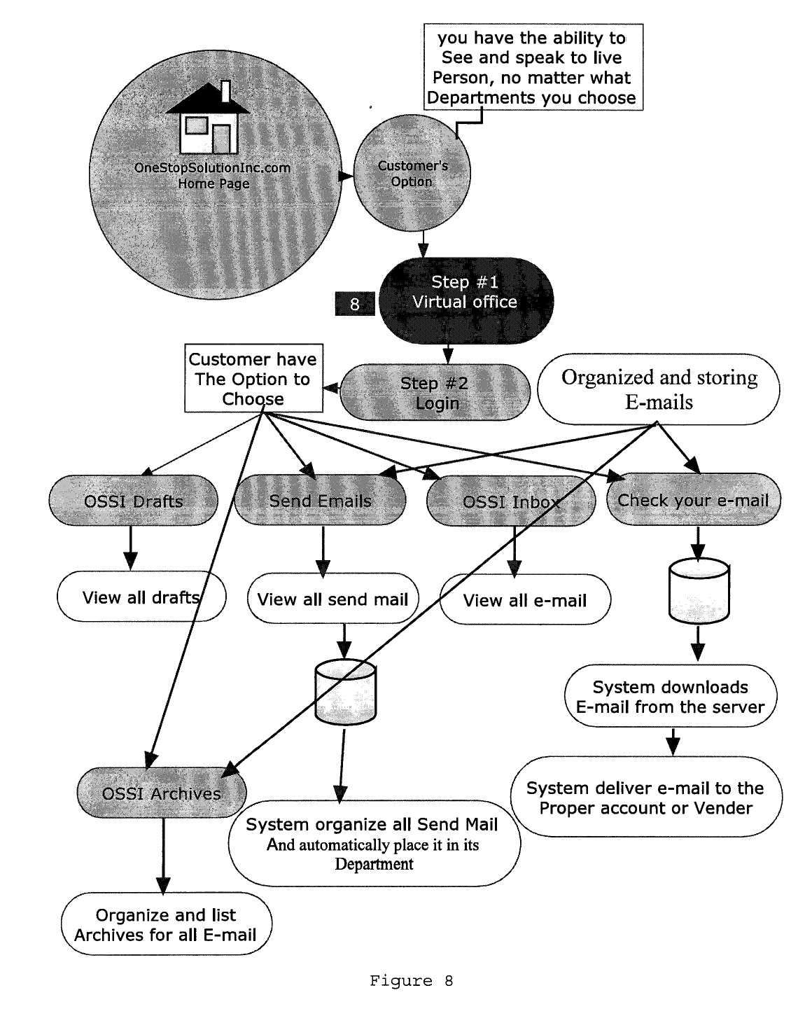

FIG. 9 is a flow chart showing the system and method of the present invention utilizing a virtual office.

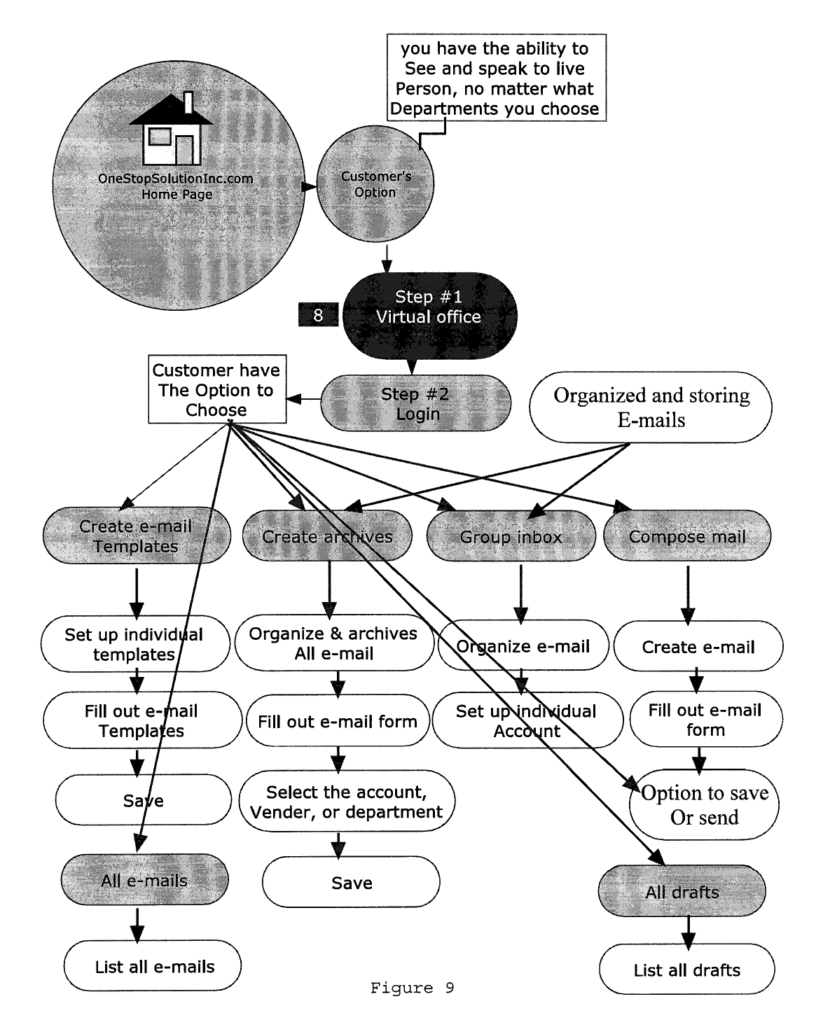

FIG. 10 is a flow chart showing the system and method of the present invention utilizing a virtual office.

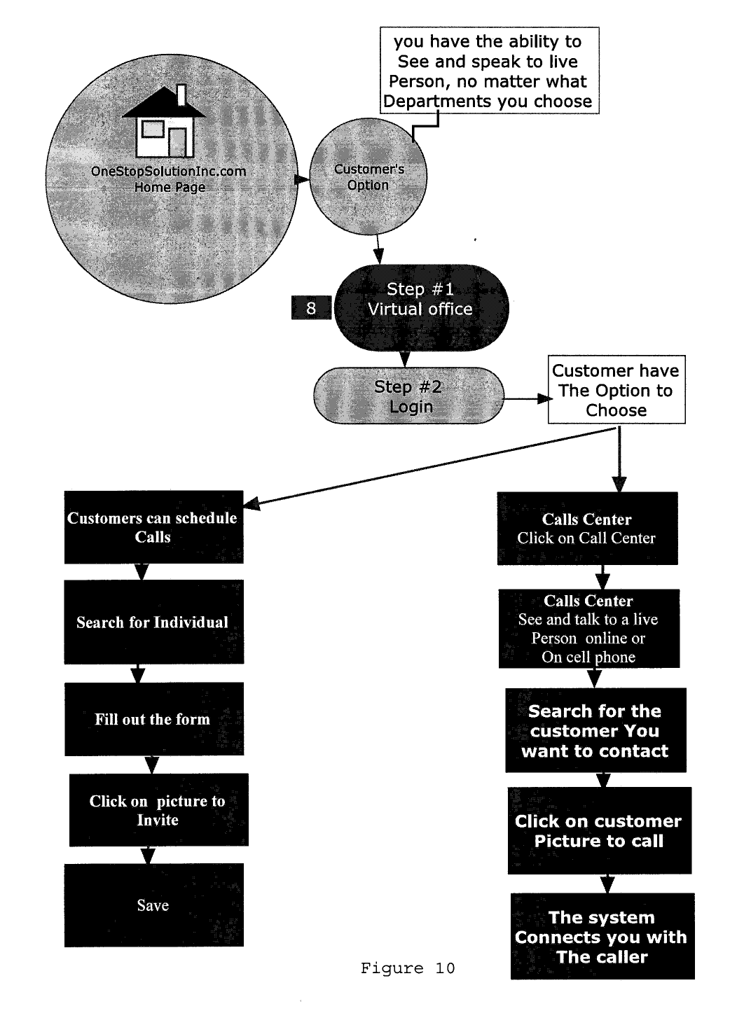

FIG. 11 is a flow chart showing the system and method of the present invention utilizing a virtual office.

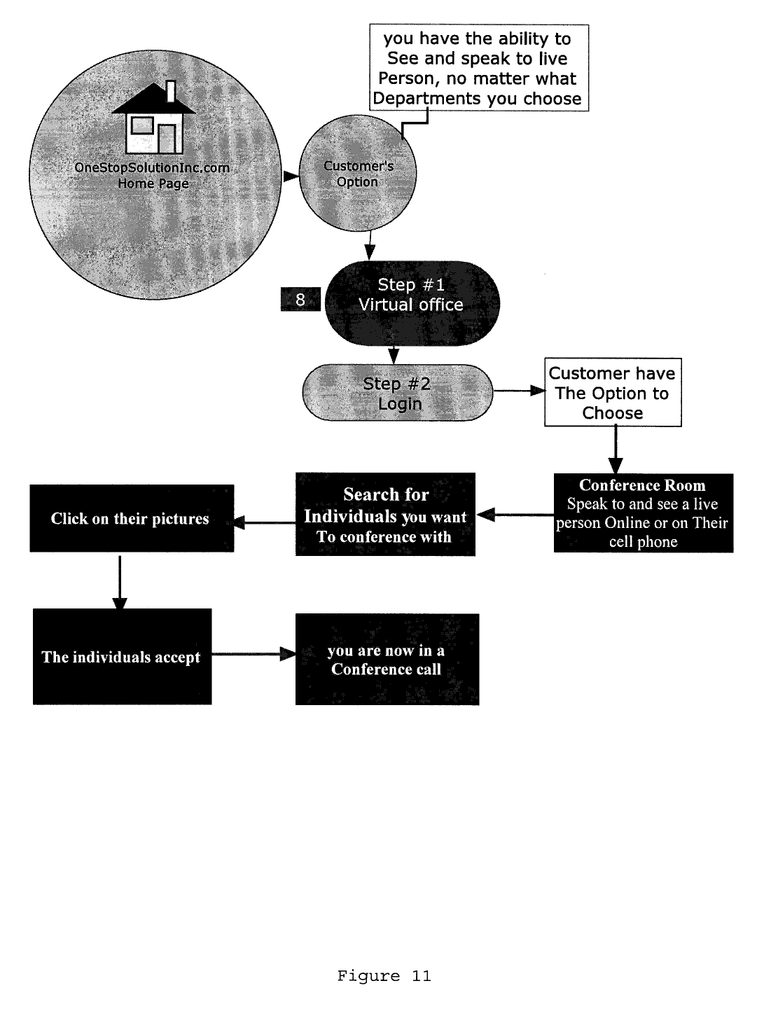

FIG. 12 is a flow chart showing the system and method of the present invention utilizing a virtual office.

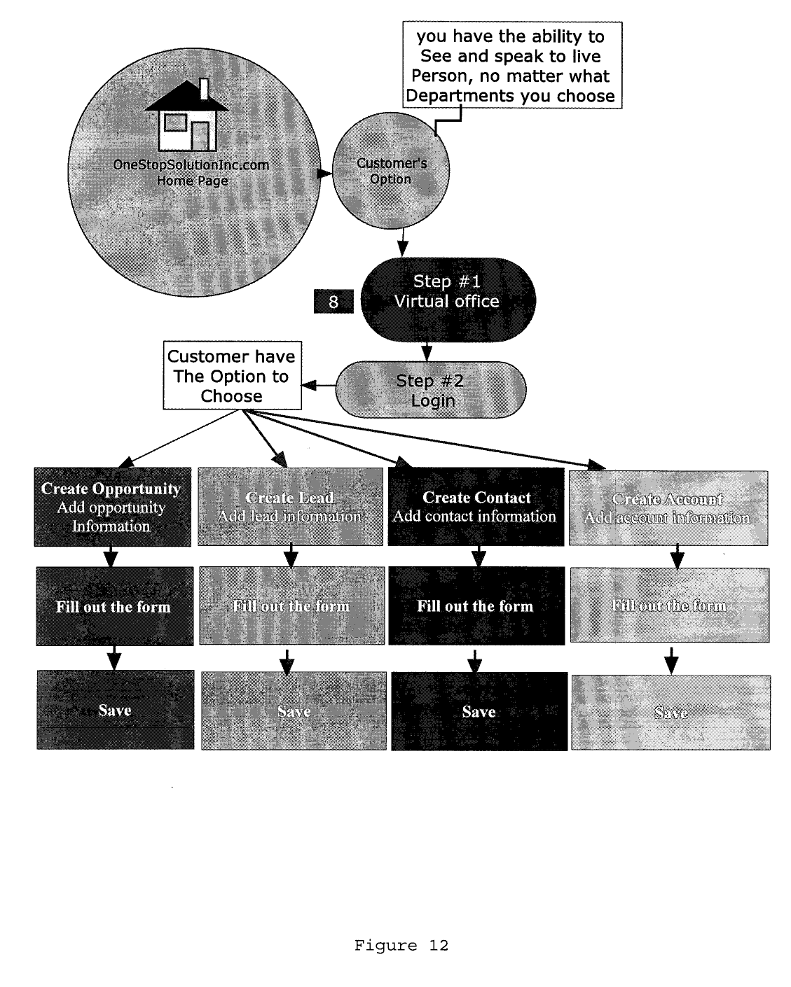

FIG. 13 is a flow chart showing the system and method of the present invention utilizing a virtual office.

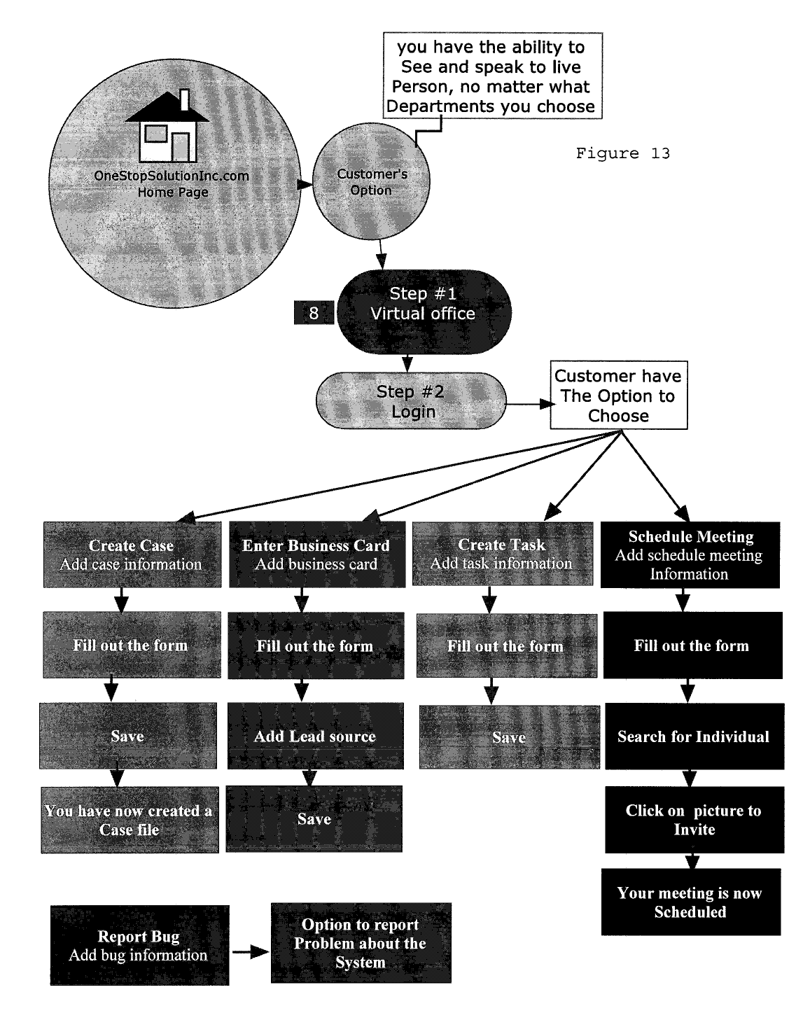

FIG. 14 is a flow chart showing the system and method of the present invention utilizing a virtual office.

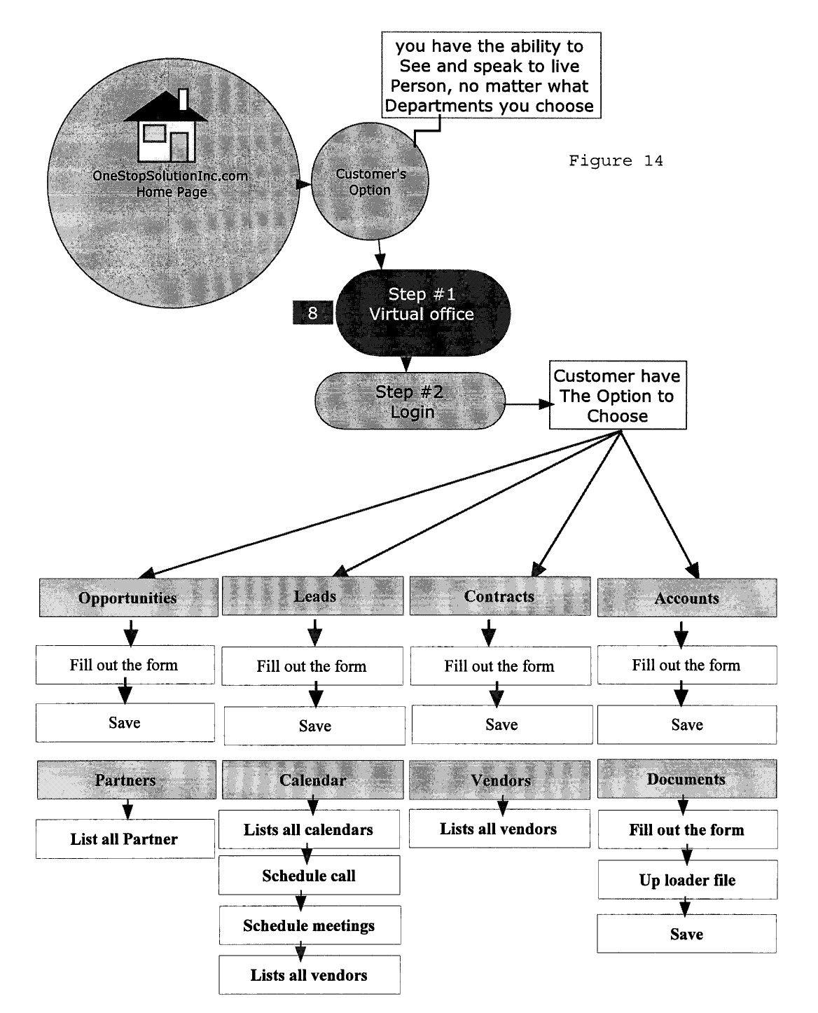

FIG. 15 is a flow chart showing the system and method of the present invention utilizing a virtual office.

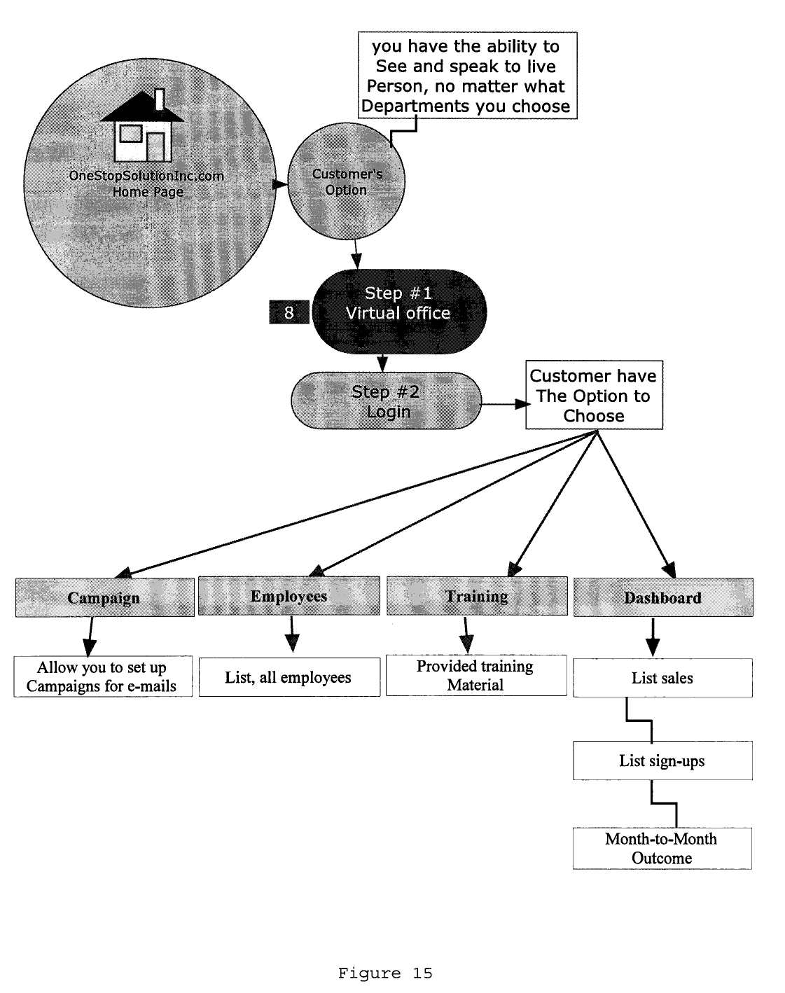

FIG. 16 is a flow chart demonstrating the system and method of the present invention as a social work place.

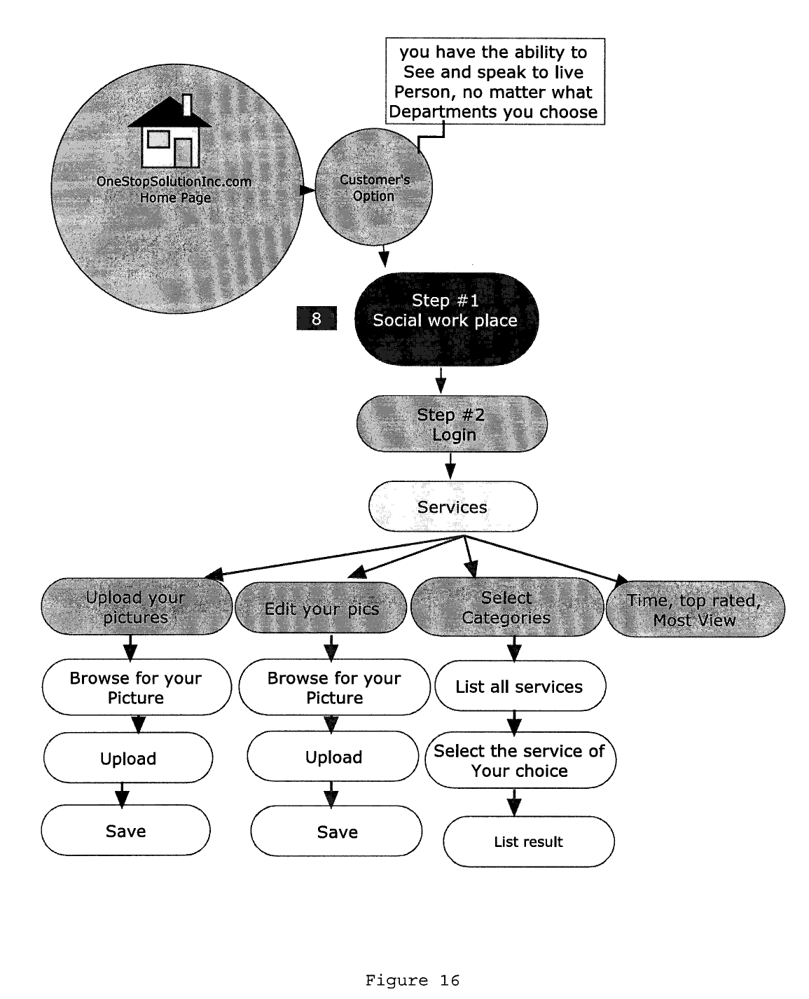

FIG. 17 is a flow chart demonstrating the system and method of the present invention as a social work place.

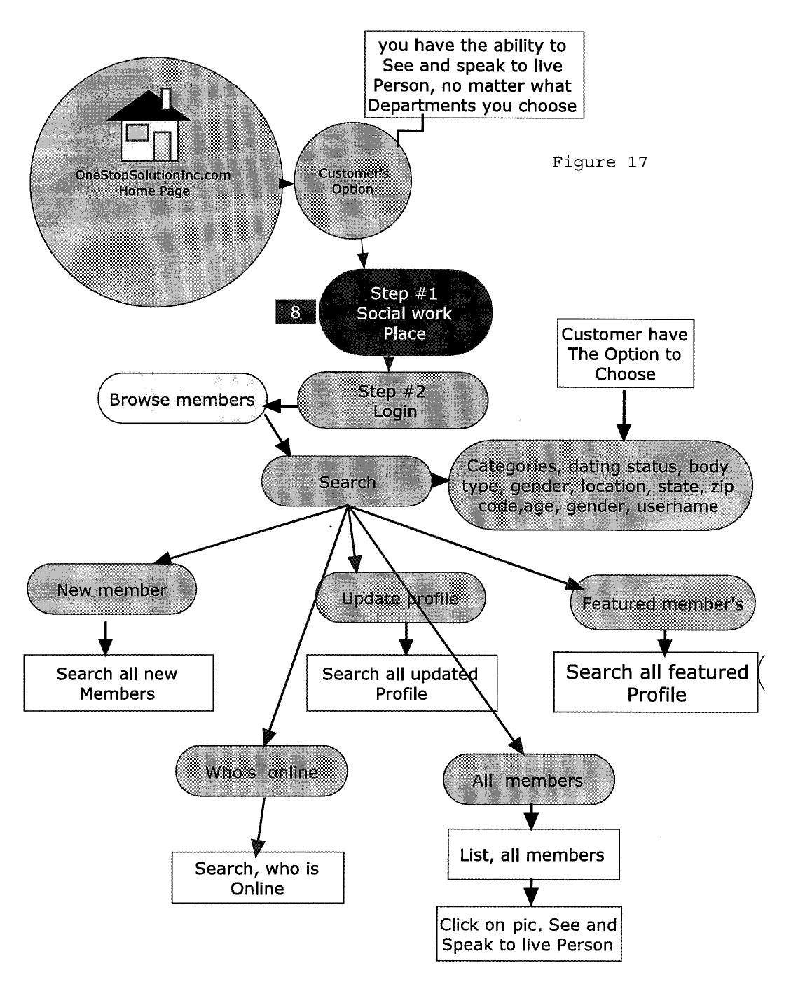

FIG. 18 is a flow chart demonstrating the system and method of the present invention as a social work place.

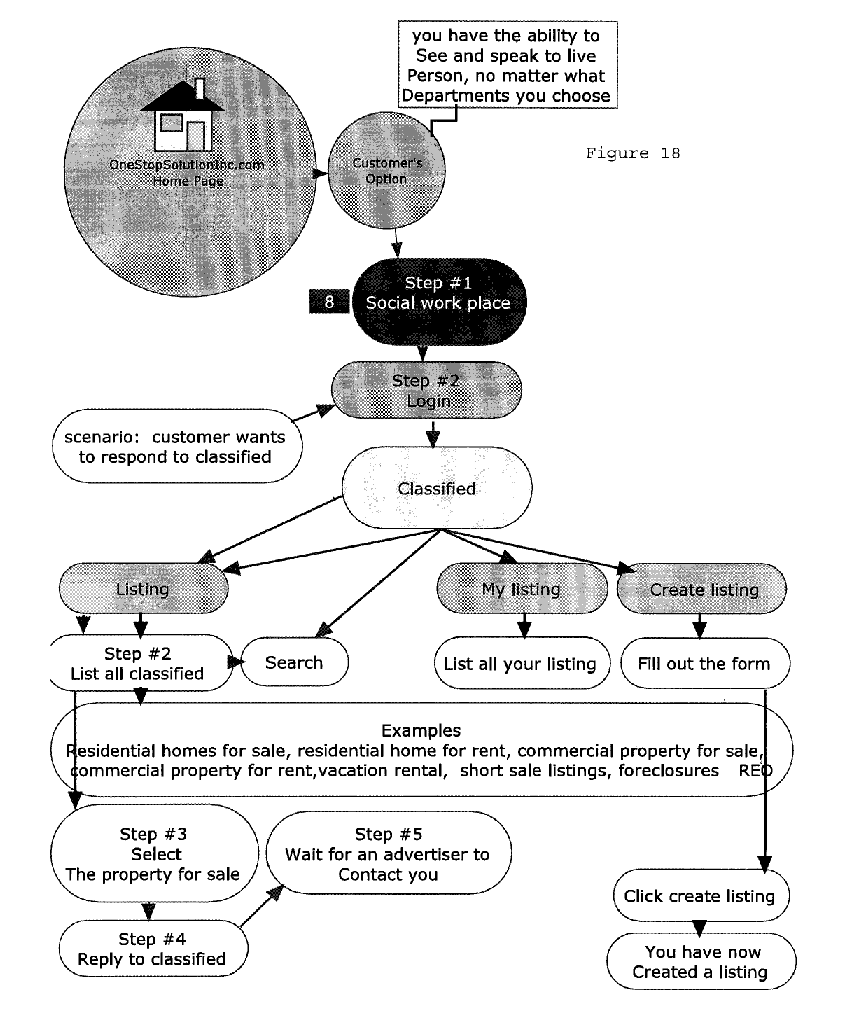

FIG. 19 is a flow chart demonstrating the system and method of the present invention as a social work place.

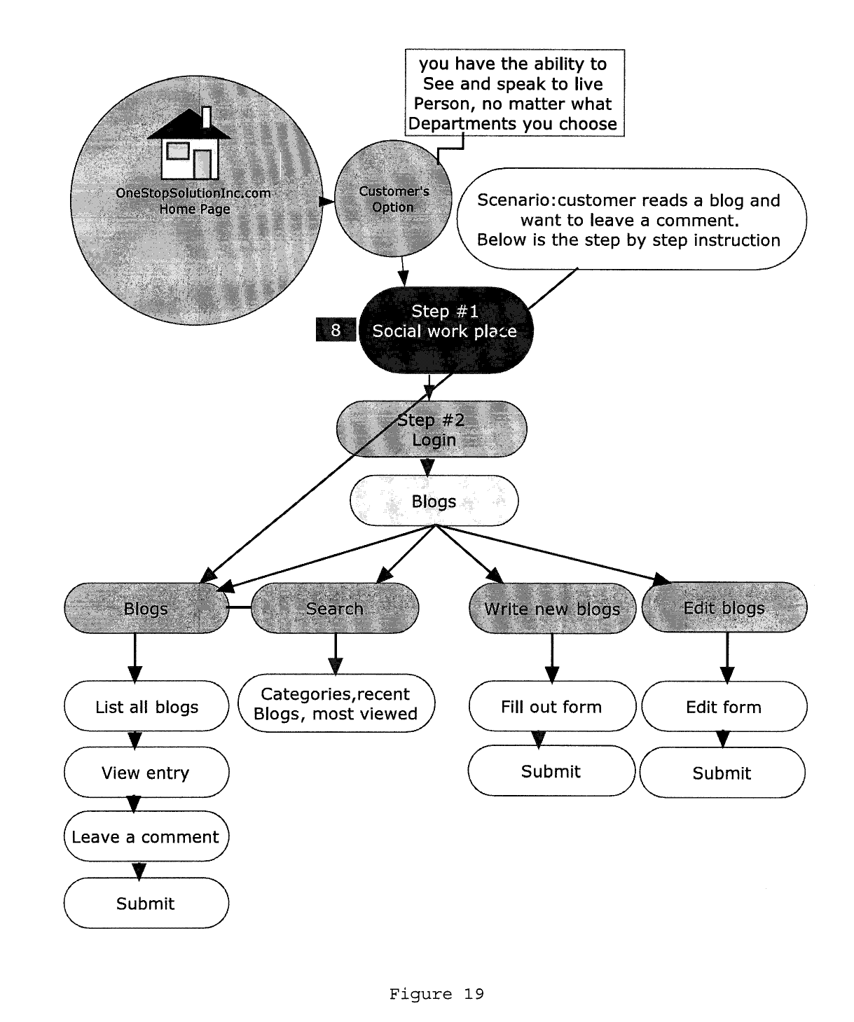

FIG. 20 is a flow chart demonstrating the system and method of the present invention as a social work place.

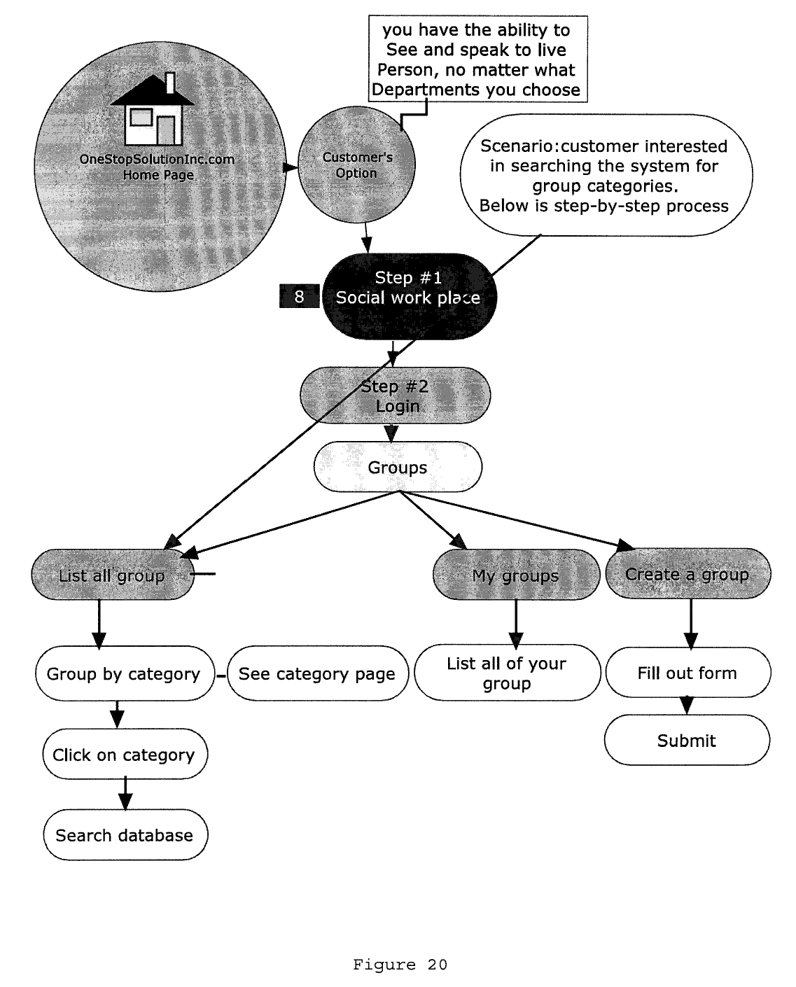

FIG. 21 is a flow chart demonstrating the system and method of the present invention as a social work place.

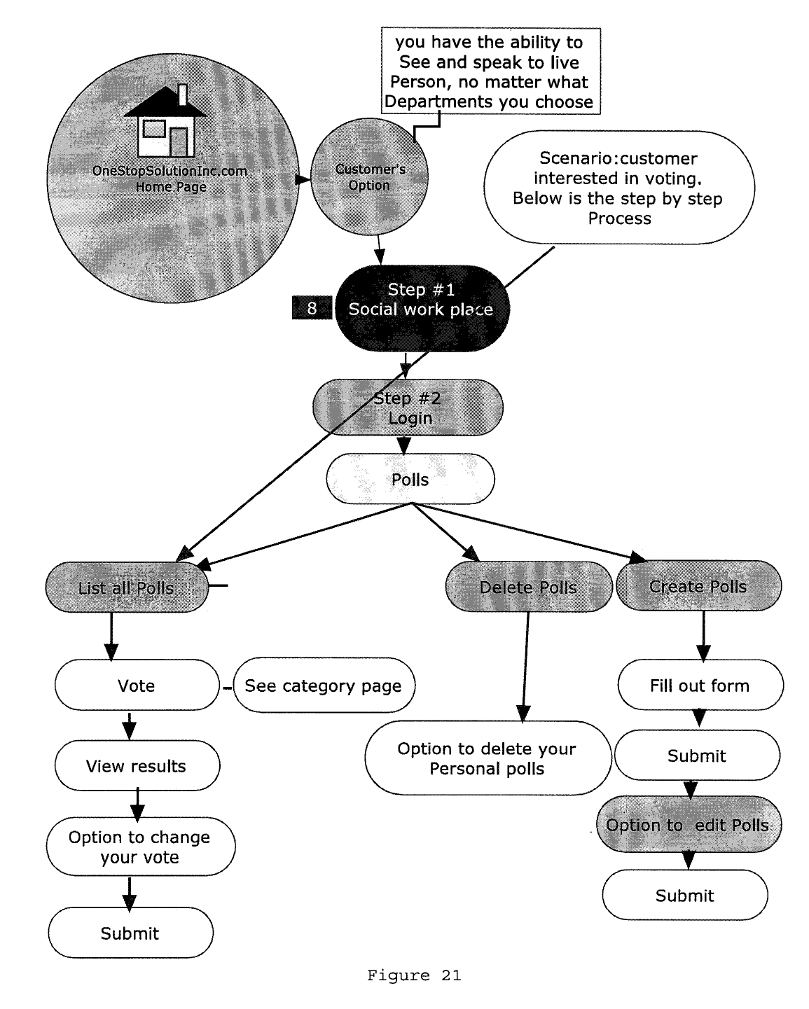

FIG. 22 is a flow chart demonstrating the system and method of the present invention as a social work place.

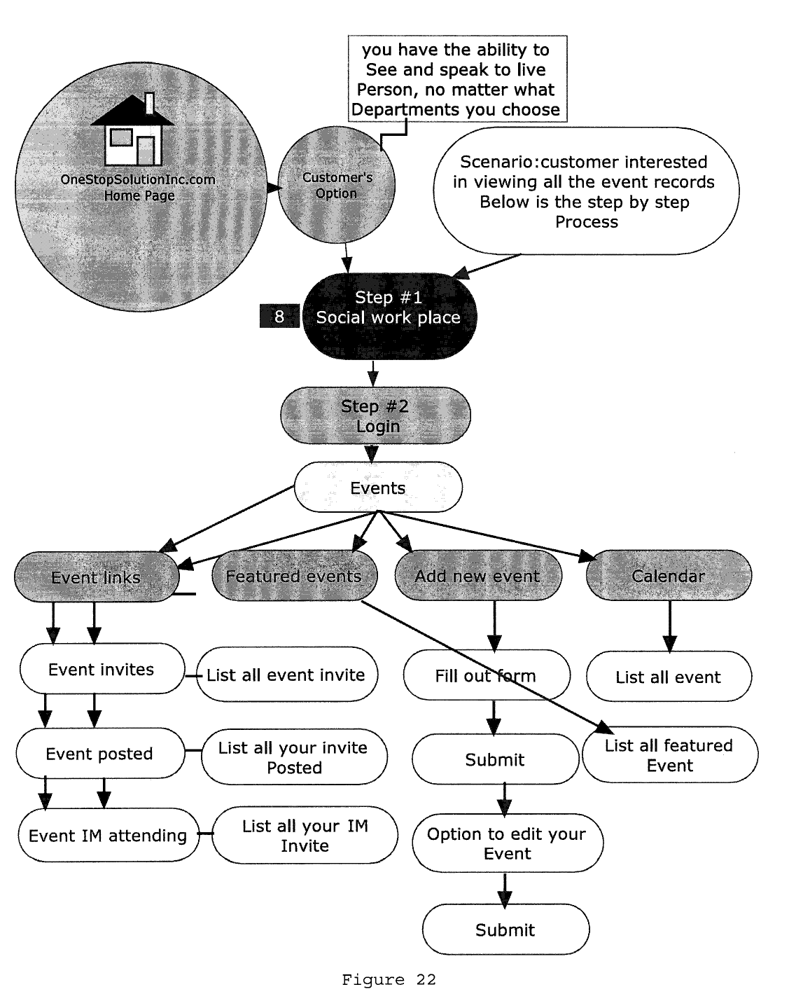

FIG. 23 is a flow chart demonstrating the system and method of the present invention as a social work place.

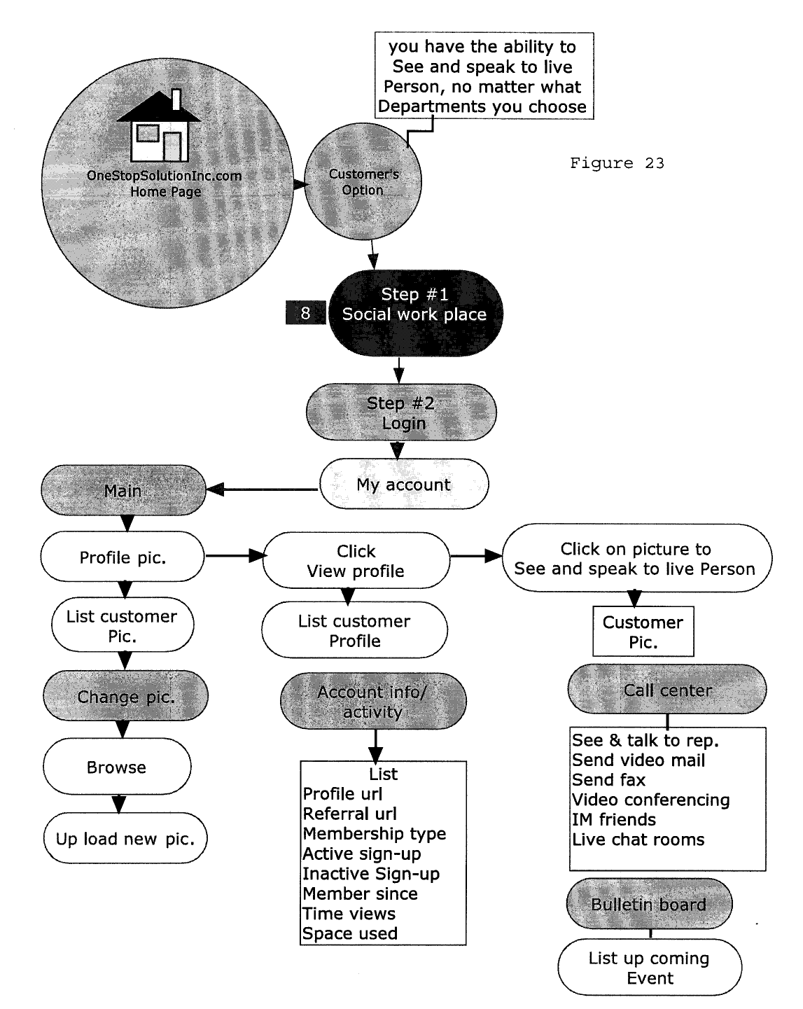

FIG. 24 is a flow chart demonstrating the system and method of the present invention as a social work place.

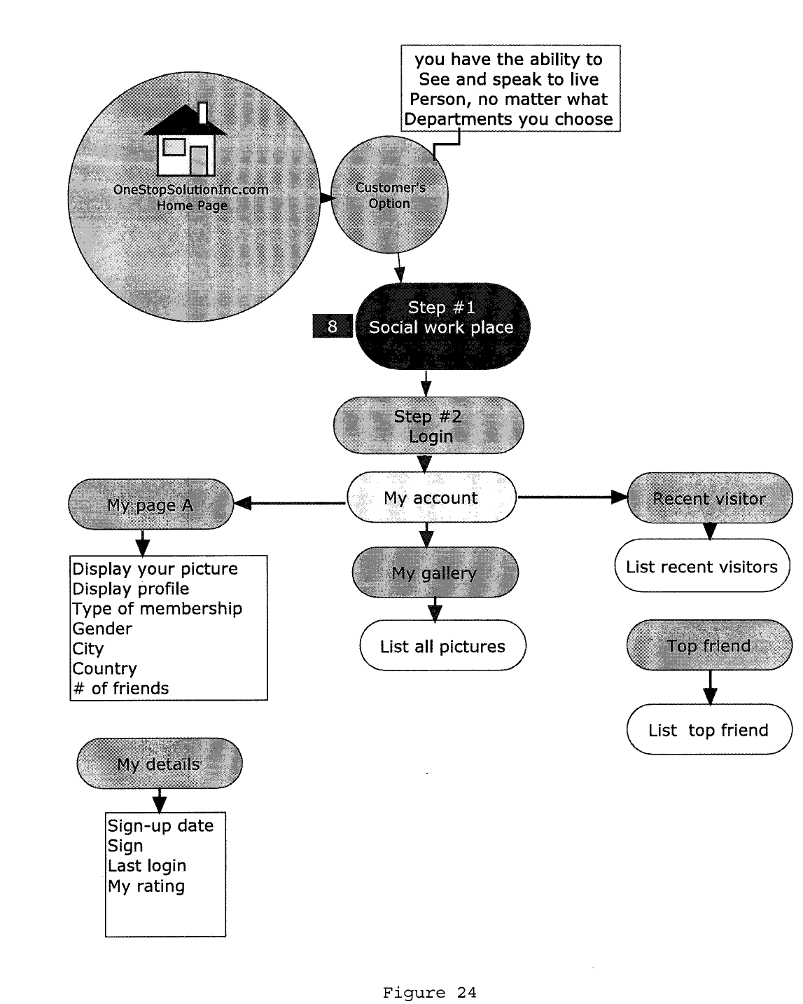

FIG. 25 is a flow chart demonstrating the system and method of the present invention as a social work place.

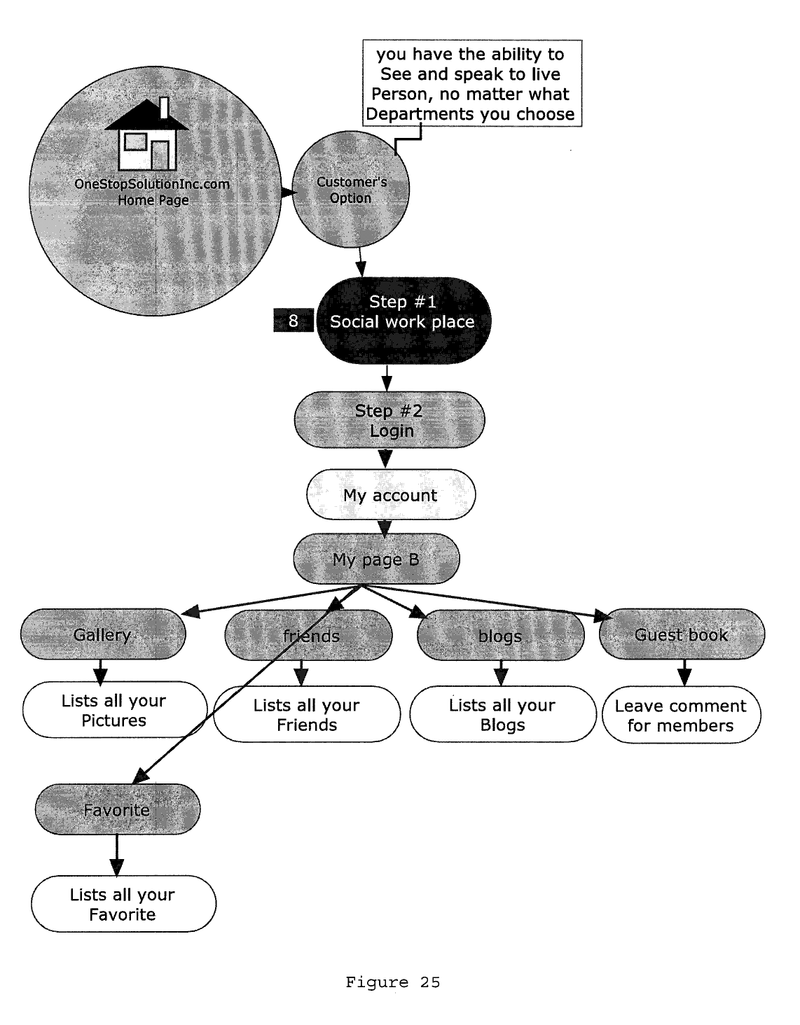

FIG. 26 is a flow chart demonstrating the system and method of the present invention as a social work place.

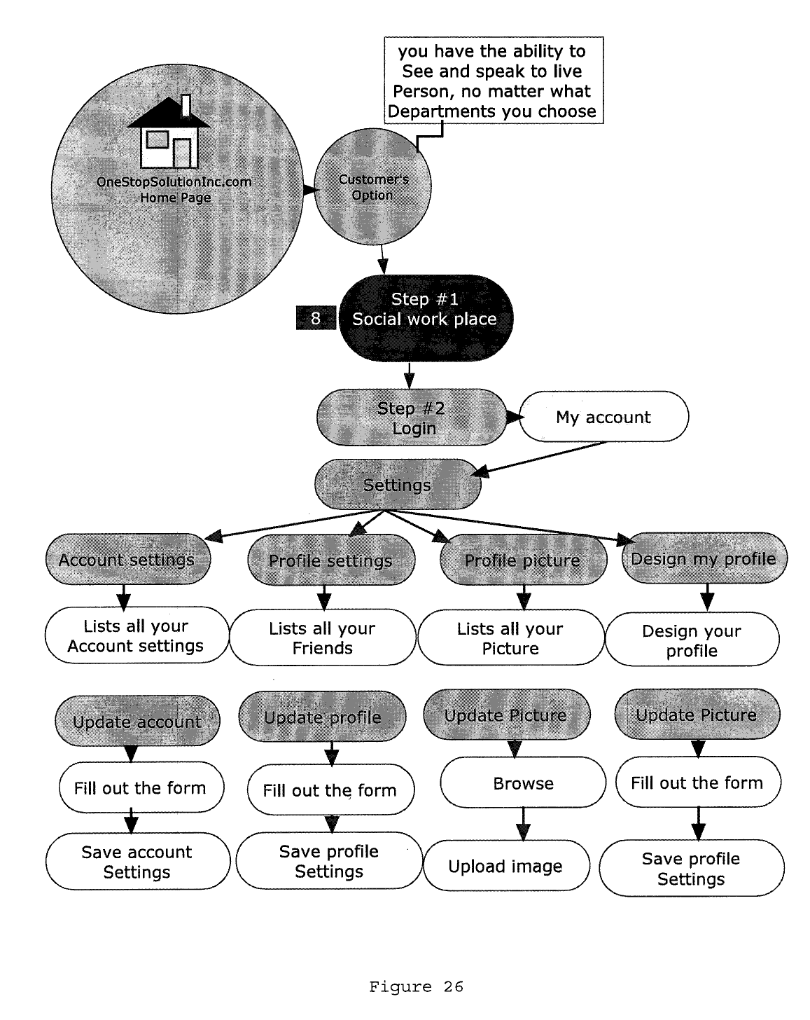

FIG. 27 is a flow chart demonstrating the system and method of the present invention as a social work place.

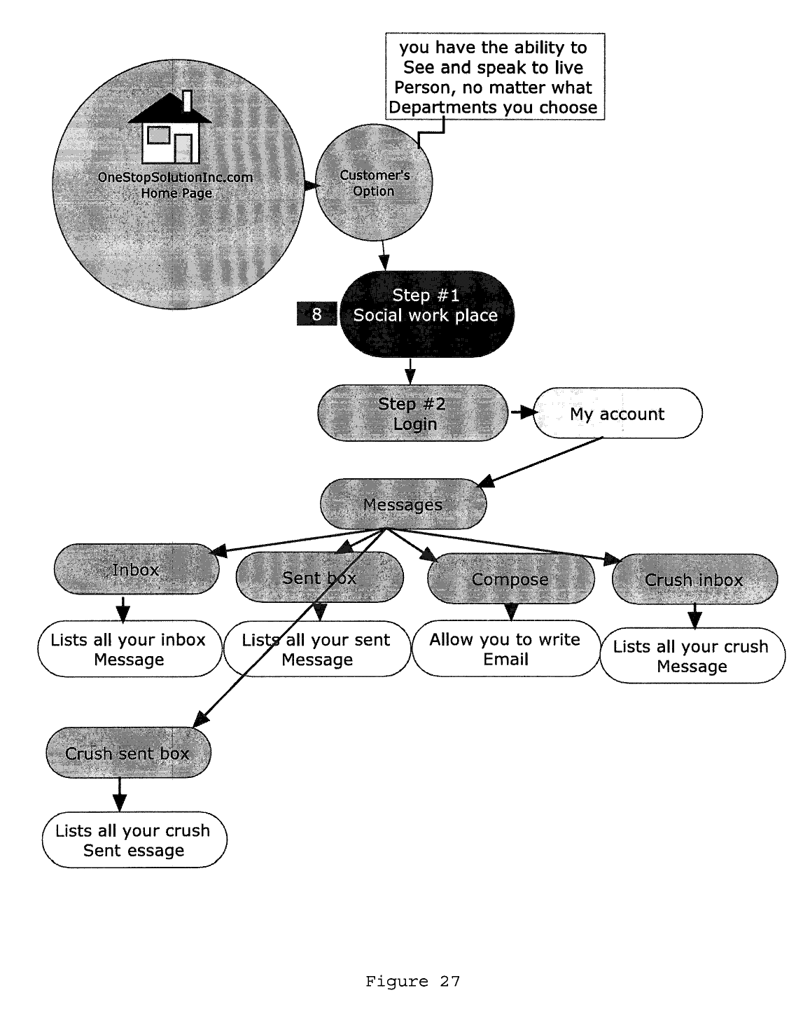

FIG. 28 is a flow chart demonstrating the system and method of the present invention as a social work place.

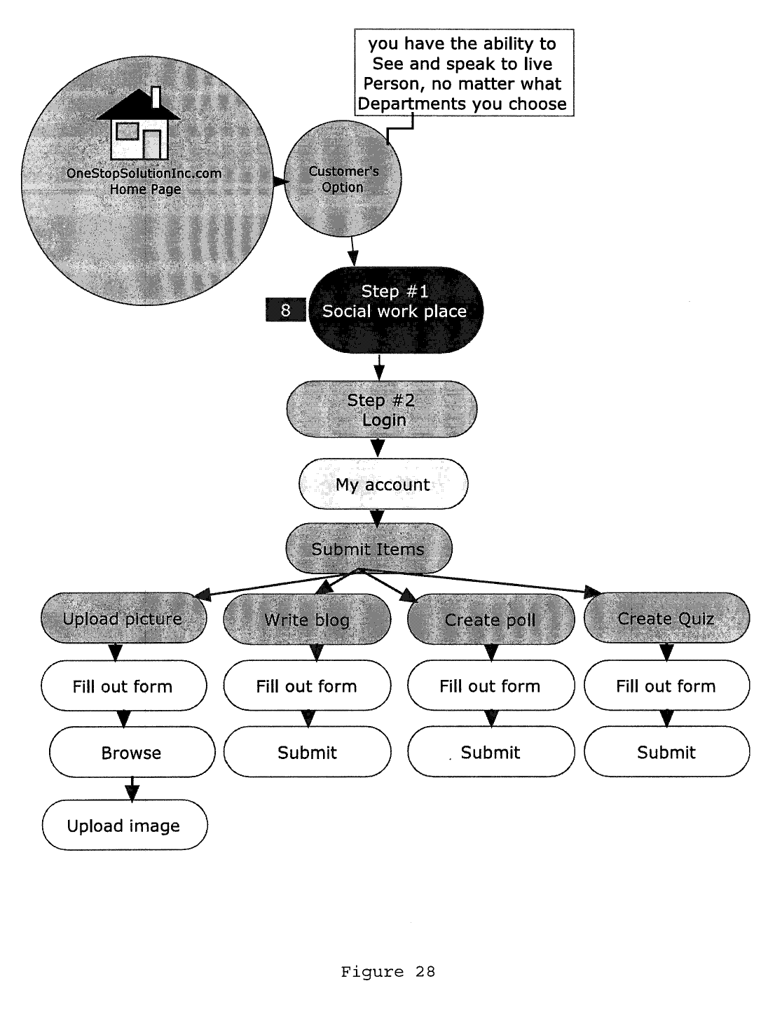

FIG. 29 is a flow chart demonstrating the system and method of the present invention as a social work place.

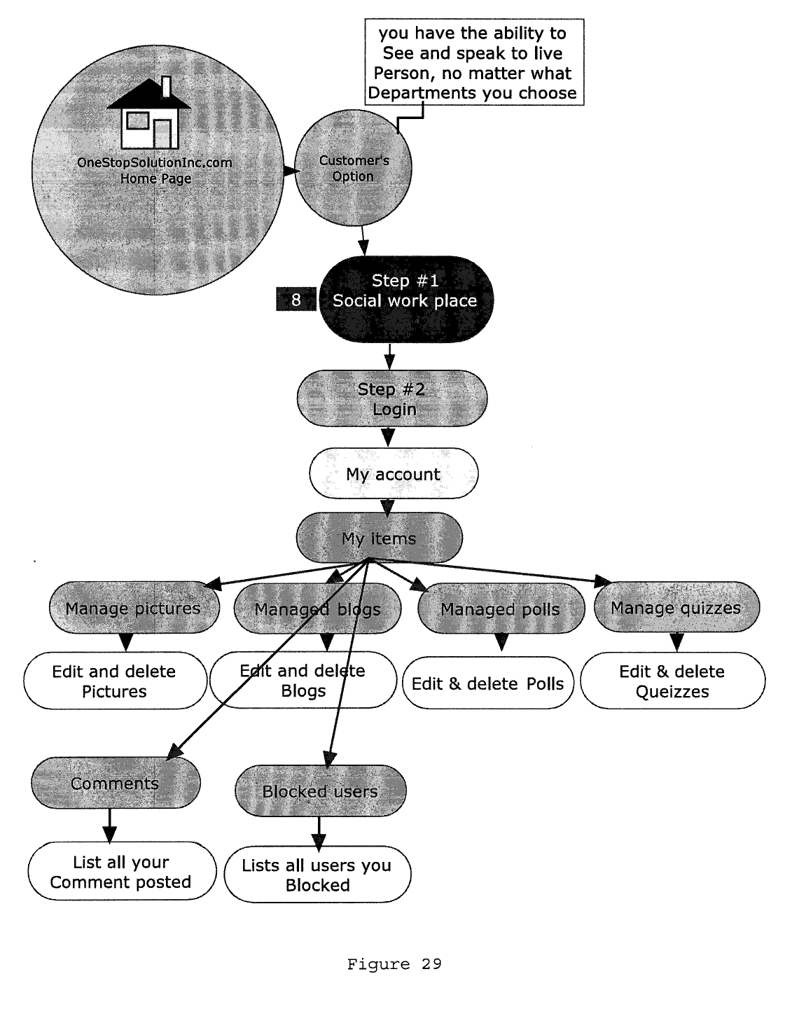

FIG. 30 is a flow chart demonstrating the system and method of the present invention as a social work place.

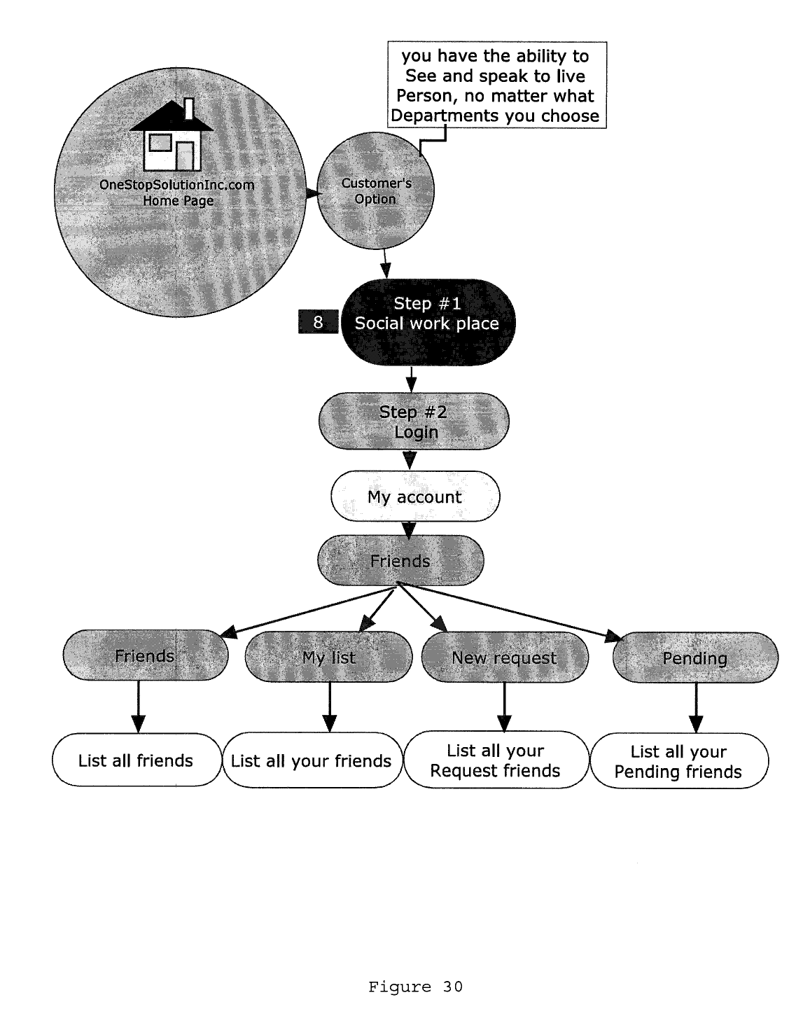

FIG. 31 is a flow chart demonstrating the system and method of the present invention as a social work place.

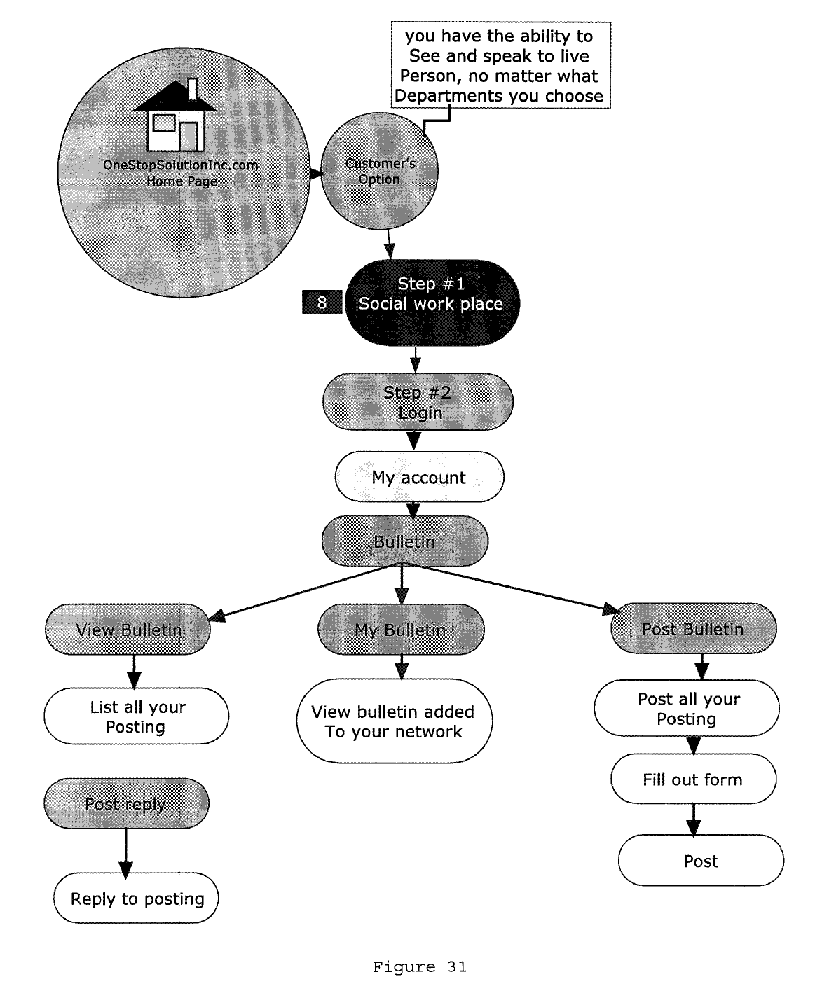

FIG. 32 is a flow chart demonstrating the system and method of the present invention as a social work place.

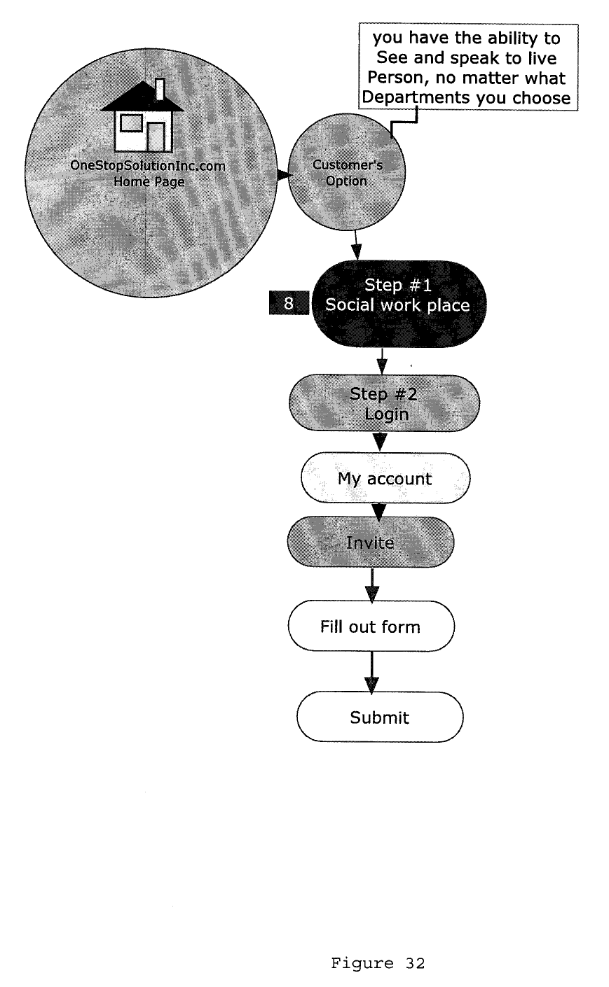

FIG. 33 is a flow chart demonstrating the system and method of the present invention as a social work place.

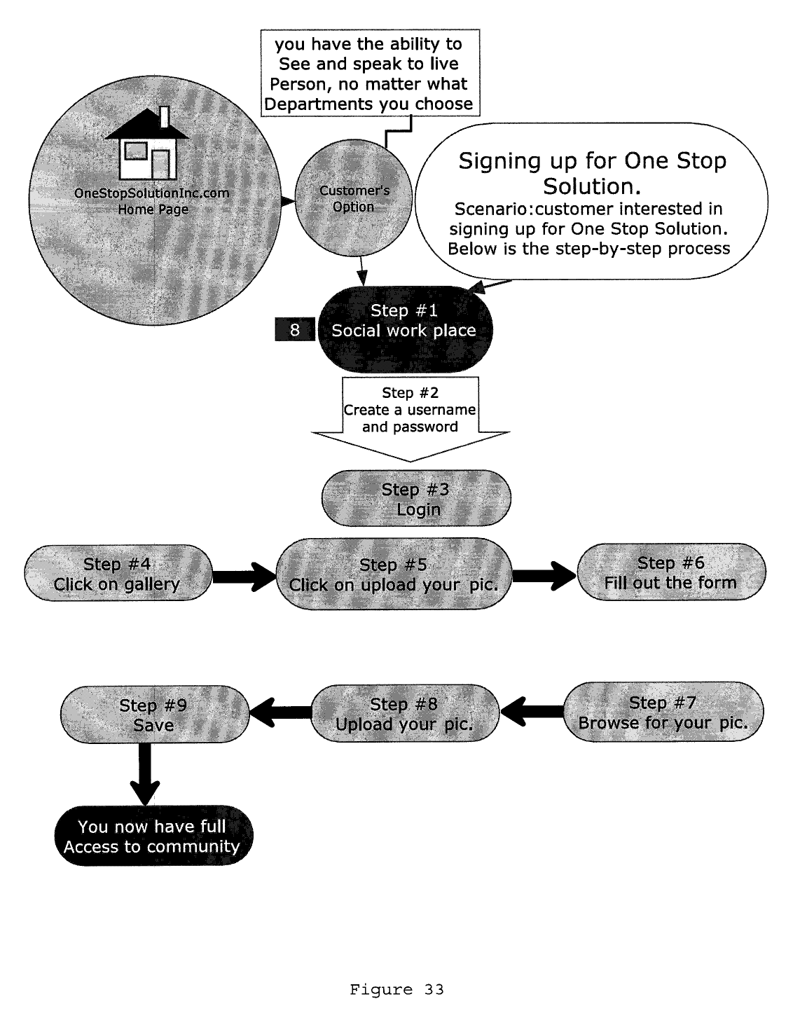

FIG. 34 is a flow chart demonstrating the system and method of the present invention as a social work place.

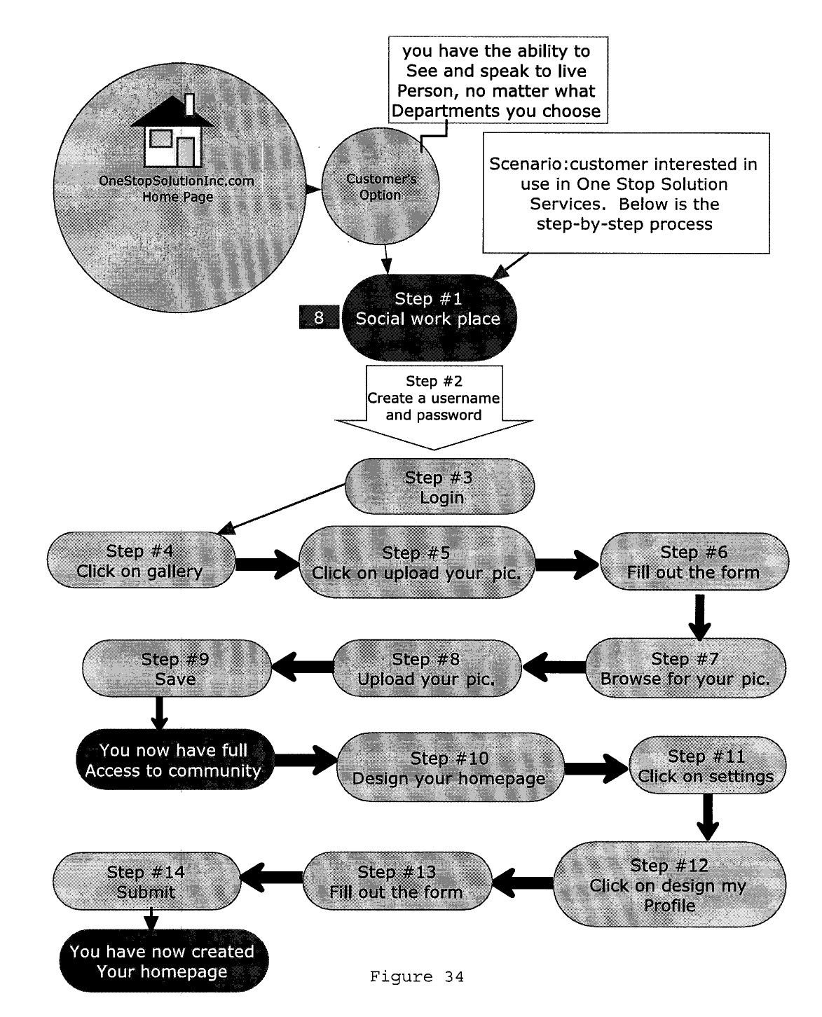

FIG. 35 is a flow chart demonstrating the system and method of the present invention and the ability to visually contact a live representative over the internet.

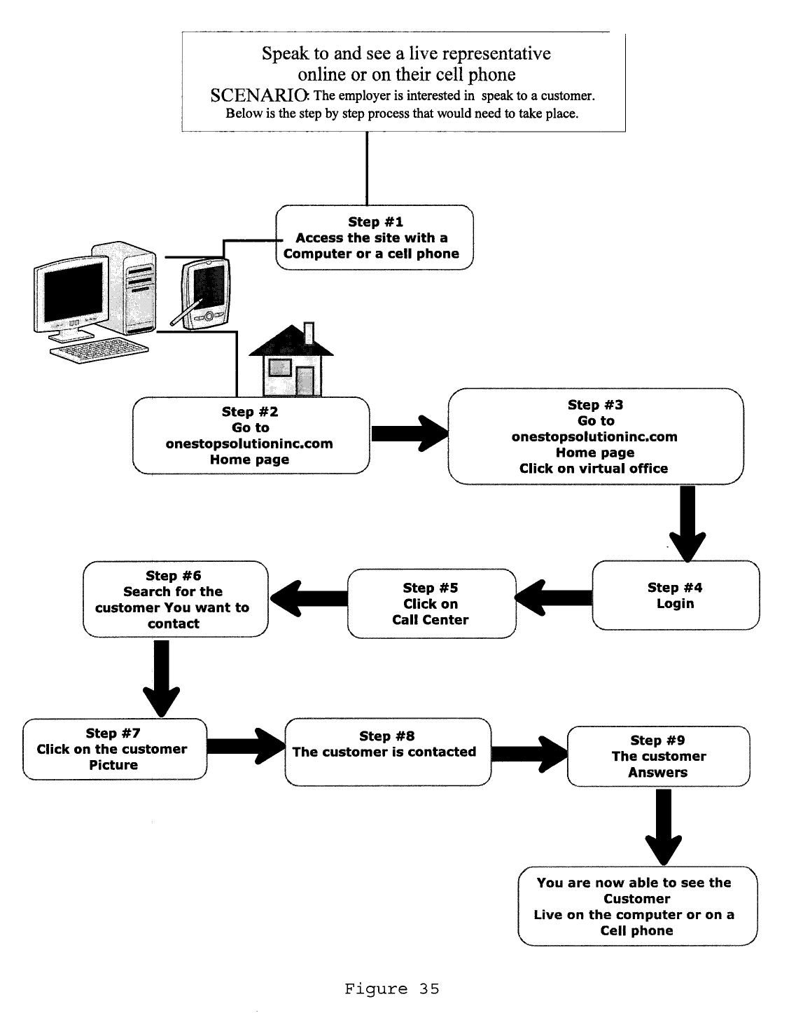

FIG. 36 is a flow chart demonstrating the system and method of the present invention in a e-mail organizational environment.

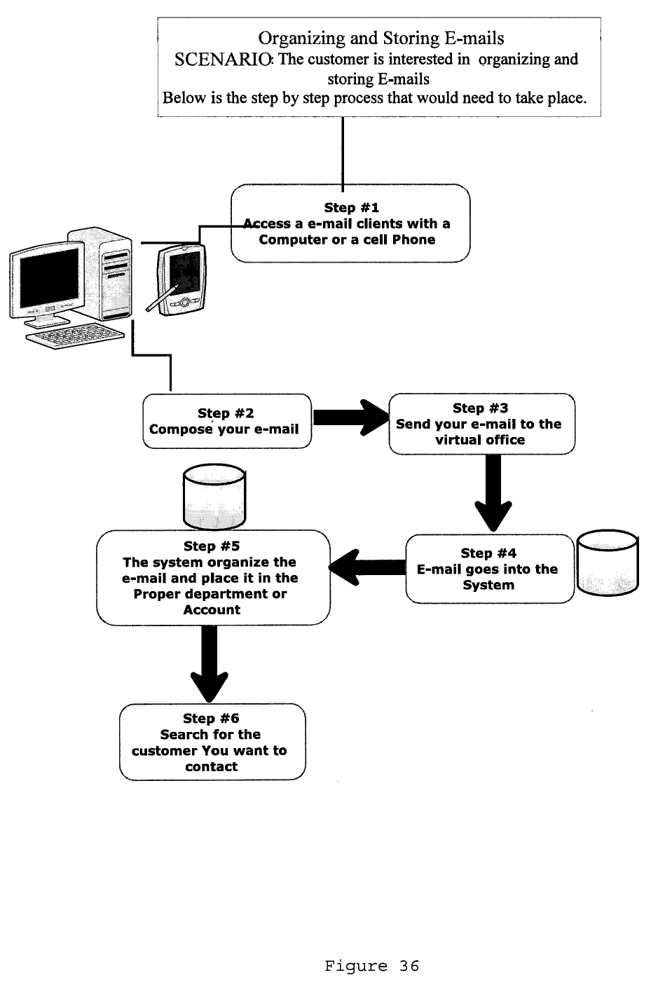

FIG. 37 is a flow chart showing the system and method of the present invention in an environment used for global contacts and networking.

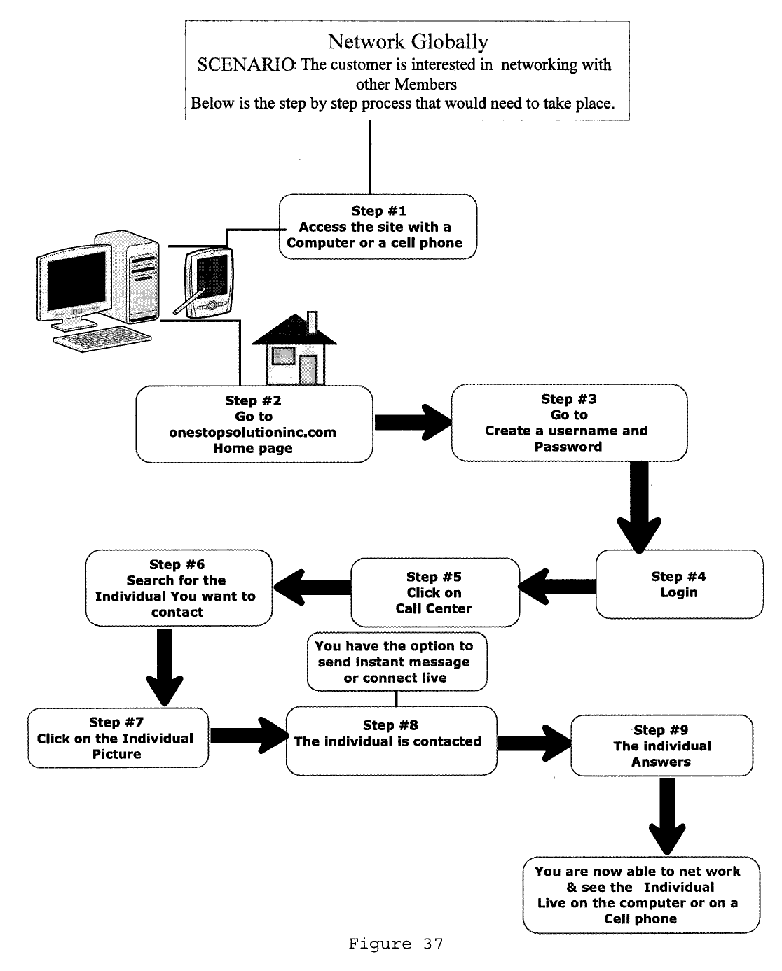

FIG. 38 is a flow chart showing the system and method of the present invention in an environment utilizing video e-mail.

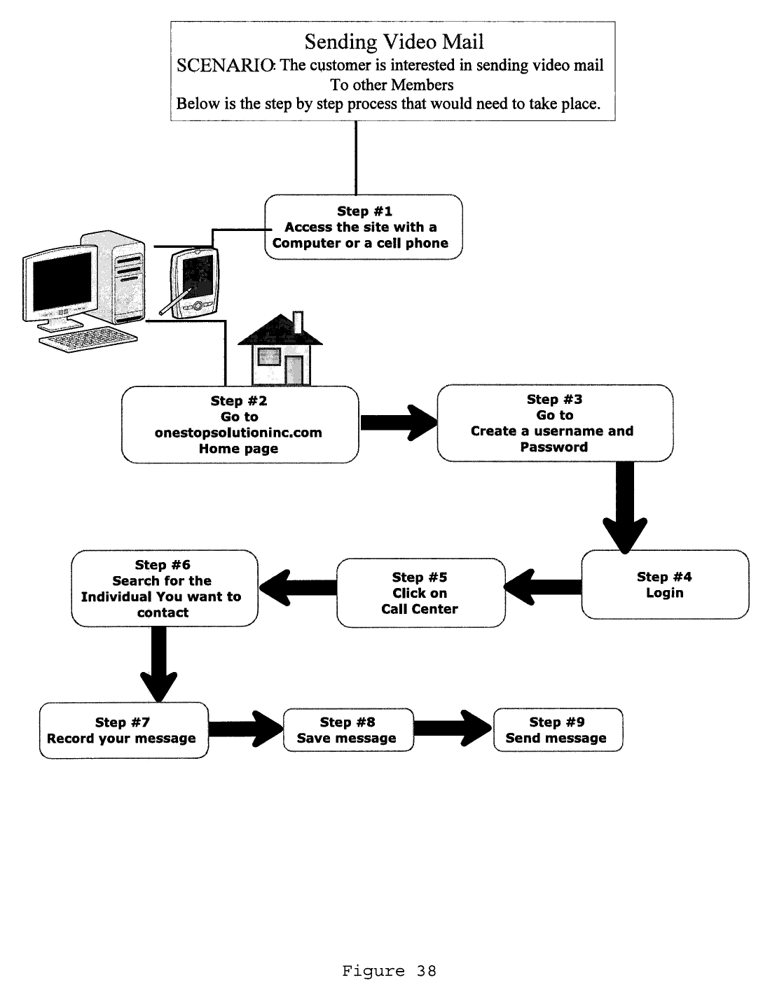

FIG. 39 is a flow chart showing the system and method of the present invention in an environment relating to social interaction.

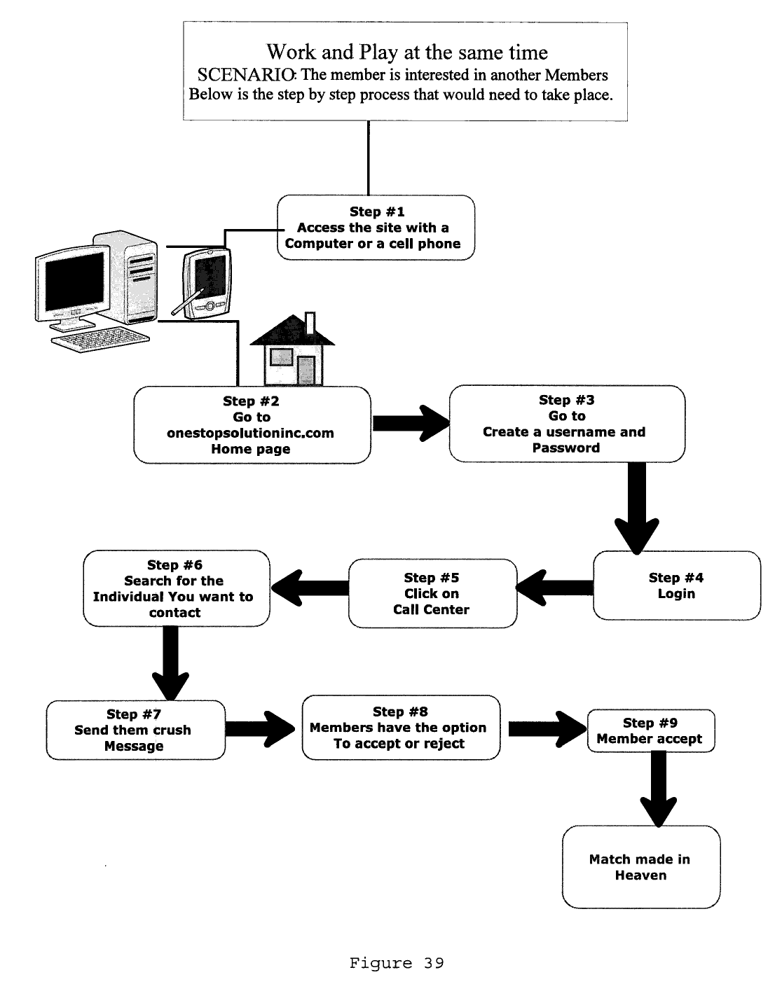

FIG. 40 is a flow chart showing the system and method of the present invention demonstrating an overall scope of the system and method of the present invention.

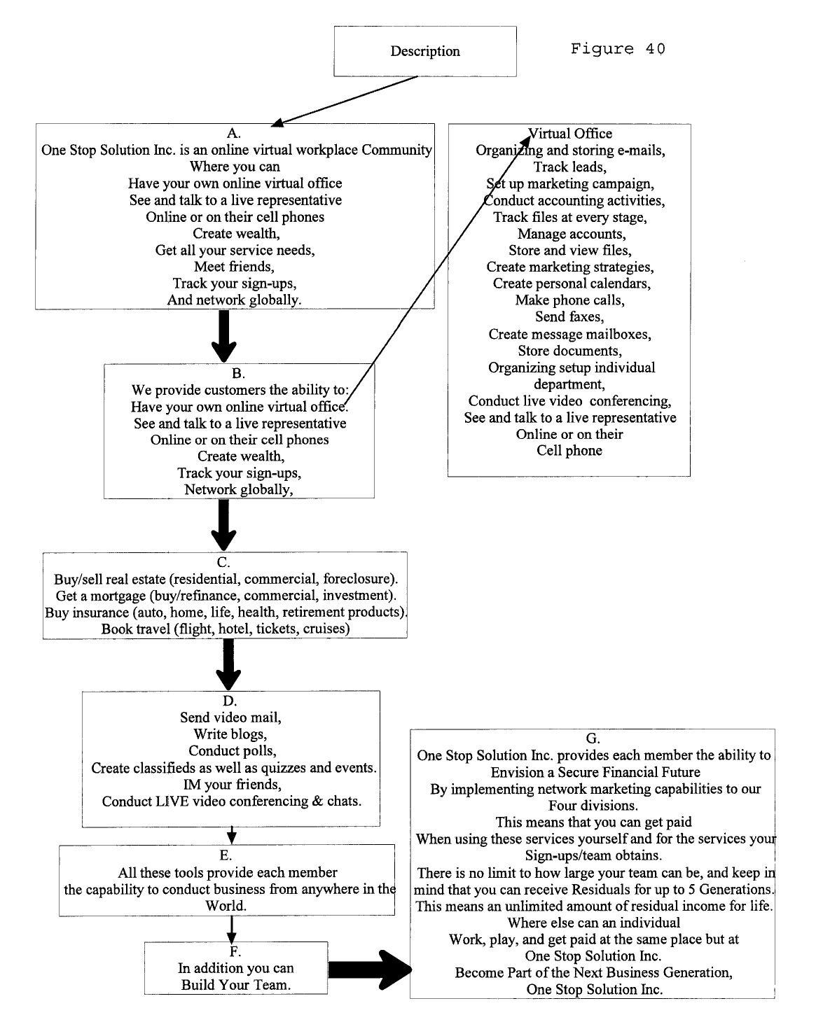

### DETAILED DESCRIPTION OF THE PREFERRED EMBODIMENT

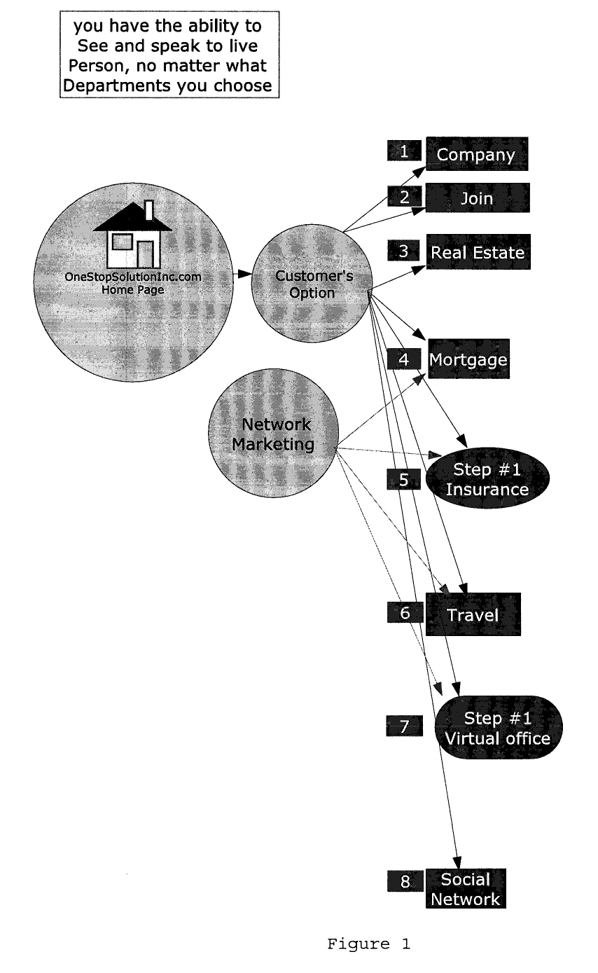

Referring now to the figures, there is provided a networked communications system and virtual community accessed therewith, in accordance with one particular embodiment of the present invention. More particularly, referring now to FIG. 1, there is provided a “virtual” community resident on a server or servers of a computer system at a location, or at a plurality of distributed locations, accessible through the network. The server(s) upon which the “virtual” community is hosted, is/are connected to an online network, which is, preferably, the Internet. As such, customers, desirous of accessing the virtual community, can connect to the network using their own personal computer systems, PDA devices, and/or telephones, and access the “virtual” community.

The virtual community of the instant invention will provide customers with a variety of services and entertainment options. For example, software resident on the server(s) of the virtual community will operate to provide customers with such services as email, video mail, the creation and accessing of web logs (i.e., “blogs”), the transmission and receipt of real-time “instant messages”, the creation and accessing of classifieds, quizzes, and event notices, as well as online events.

Further, the software can be interacted with by the customer to accommodate the performance of certain transactions. For example, by accessing the system of the virtual community across the network, a customer could, optionally conduct live conferencing and chats, including video conferencing utilizing webcams, buy or sell real estate (residential, commercial, foreclosures, etc.), obtain a mortgage (purchase, refinance, commercial, investment, residential, etc.), buy insurance (auto home, life, health, retirement products, etc.) and/or book travel (flight, hotel, ticket events, cruises, shows, vacation packages, etc.).

Additionally, the virtual community of the instant invention can include a staff of live operators, interacting with the virtual community, through both the online network, as well as through the telephone network. As such, it is envisioned that, in the most preferred embodiment of the virtual network of the present invention, live operators provide customer service assistance, either online (via computer and/or PDA) and/or over telephone (i.e., by cell phone or landline). Additionally, if desired, the operators communicating with customers through the virtual community can be contacted online, and communicated with using videoconferencing software and webcams. As such, the virtual community provides the customer with a hospitable environment with which to transact.

The customer interactions with the virtual community of the instant invention are further enhanced by giving each customer (i.e., member) the ability to personally customize their interaction with the virtual community. Each customer can set up a personalized, online “virtual office” that is hosted by and on the virtual community. As such, each customer can design the look and feel of their “virtual office”, as well as the services offered by their “virtual office”. For example, a member can join the virtual community by enrolling with and, if necessary, paying for, a virtual office (i.e., forming a “company”) to be hosted on the virtual community. The “virtual office” for that company is designed according to that company's membership level and/or specifications. The resultant “virtual office” for the company is then hosted on the server(s) of the virtual community, for example, in the form of a website for that company. When accessing the “virtual office” of the company, the customer can use a standard internet type browser. Access to a company's virtual office can be open to the public, or restricted to members of that company, as desired. As members of the company browser into and/or log into the “virtual office” for their company, they can have access to the services selected by their company for inclusion in the company's virtual office. For example, one company may authorize the users of the virtual office to have access to email and videoconferencing, only, while another company may authorize email, but not videoconferencing, and access to commercial transactions, such as the buying of insurance through the virtual community, via the company's virtual office.

In the presently described preferred embodiment, the virtual community of the instant invention offers each member/company the ability to transact business with four “divisions” of the virtual community (i.e., real estate, travel, insurance, and mortgage).

As such, instead of each member/company having to worry about the minutia of booking travel, shopping for a mortgage, insurance or real estate, each “division” of the virtual community can handle the details, allowing the member to focus on his or her own business. Note that, although four “divisions” are described in the present preferred embodiment, a greater number or lesser number of divisions can be supported by the virtual community, as desired.

Using their own personalized virtual office, each customer can transact business and keep in touch with other members and/or business associates from anywhere in the world.

Additionally, a customer subscribing to the virtual community of the instant invention will also derive social benefits from their participation with the community. In fact, the virtual community of the instant application, by networking its customers and facilitating bi-directional communication, can permit customers to:
meet friends;
network on a global scale;
create wealth by becoming part of a networking scheme;
build network “marketing teams”; and
keep track of their “sign-ups” and “friends.

Further, each member has the ability to create wealth by bringing in additional “team members” to the virtual community. For example, by offering the benefits of the virtual community to others, each member can sign-up other members to their “team” or company. Benefits can be awarded by the virtual community for signing up new members to a team. For example, a team member who signs up another individual can be awarded a bonus payment for services purchased from the divisions of the virtual community by the recruited member. Such bonus payments can be a flat amount, or can be a percentage of the fees paid by the recruited member for the services rendered by the division. For example, if John recruits Susie, and Susie purchases plane tickets through the virtual community, John will receive a bonus payment for Susie's purchase. Such payments can be awarded as monetary payments, online credits and/or other prize awards, as desired.

In the present preferred embodiment, the original recruiting member can received residuals for up to five generations of recruited members. If desired, more or fewer generations can be supported. However, in the present preferred embodiment, if John recruited Susie, and Susie recruited Pete, then John will also receive a bonus on services purchased by Pete, as well as on services purchased by Susie. Additionally, Susie will receive a bonus award based on purchases made by Pete. In the present embodiment, there is no limit to how large a “team” can be. Additionally, the present embodiment permits the original recruiting member to be awarded bonus payments for as long as the recruited members (and permitted generations of members recruited by recruited members) are members of the system and purchase services through the virtual community.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method for awarding a bonus, comprising the steps of:
storing information of a first individual;
associating information relating to at least a second individual referred by the first individual with the stored information of the first individual;
calculating at least a first portion of a bonus for the first individual based on an amount of services rendered by the at least a second individual.

2. The method of claim 1, wherein the at least a first portion is calculated based on the number of hours of services rendered by the at least a second individual.

3. The method of claim 2, wherein the at least a first portion is calculated as a preset flat fee for each hour billed by the at least a second individual.

4. The method of claim 1, wherein the at least a first portion is a percentage of the gross billings for services rendered by the at least a second individual.

5. The method of claim 1, wherein the bonus calculated for the first individual further includes a second portion not based on the amount worked by the at least a second individual.

6. The method of claim 1, wherein the second portion includes a finder's fee.

7. The method of claim 1, wherein the at least a second individual is directly referred by the first individual.

8. The method of claim 1, wherein the at least a second individual is indirectly referred by the first individual.

9. The method of claim 1, further including the steps of:
associating information relating to at least a third individual referred by the at least a second individual with the stored information of the first individual;
calculating at least a second portion of a bonus for the first individual based on an amount of services rendered by the at least a third individual; and
adding the at least a first portion and the at least a second portion to determine a bonus for the first individual.

10. The method of claim 9, wherein the at least a first portion is calculated as a first preset flat fee for each hour billed by the at least a second individual and the at least a second portion is calculated as a second preset flat fee for each hour billed by the at least a third individual.

11. The method of claim 10, wherein the first preset flat fee is greater than the second preset flat fee.

12. The method of claim 9, further including the step of:
calculating at least a first portion of a bonus for the at least a second individual who referred the at least a third individual based on an amount of services rendered by the at least a third individual.

13. The method of claim 12, wherein the at least a first portion of a bonus for the first individual is calculated as a first preset flat fee for each hour billed by the at least a second individual and the at least a second portion of a bonus for the first individual is calculated as a second preset flat fee for each hour billed by the at least a third individual and the at least a first portion of a bonus for the at least a second individual is calculated as a second preset flat fee for each hour billed by the at least a third individual.

14. The method of claim 13, wherein the first preset flat fee and the third preset flat fee are the same.

15. A method for calculating a bonus, comprising the steps of:
recruiting at least a first individual by a second individual;
recruiting at least a third individual by the first individual; and
calculating a bonus for the second individual based on the hours billed by the first individual and the hours billed by the third individual.

16. The method of claim 15, further including the step of:
calculating a bonus for the first individual based on the hours billed by the third individual.

17. The method of claim 16, wherein the step of calculating the bonus for first individual includes calculating the bonus at a first rate per hour billed by the first individual and at a second rate per hour billed by the third individual, wherein the first rate and the second rate are different.

18. A system for calculating a bonus, comprising:
a user interface for entering information of a first individual, including information relating to individuals referred by said first individual and an amount of services performed by each individual referred by said first individual;
a storage medium for storing said information of said first individual, said information of said individuals referred by said first individual, and said amount of services performed by each individual referred by said first individual;
a processor for calculating the bonus due to said first individual based on said amount of services performed by each individual referred by said first individual; and
an output device for outputting the bonus calculated by said processor.

19. The system of claim 18, wherein the bonus is calculated on a preset rate per hour billed by each individual referred by said first individual.

20. The system of claim 19, wherein the preset rate is higher for individuals directly referred by said first individual then for individuals indirectly referred by said first individual.
